(19) United States
(12) Patent Application Publication
(10) Pub. No.: US 2007/0032241 A1
(43) Pub. Date: Feb. 8, 2007

(54) Radio communication systems

(76) Inventors: Adrian David Busch, Christchurch (NZ); Paul Anthony Churton, Christchurch (NZ); Shyh-Hao Kuo, Christchurch (NZ); Stefan John Lendnal, Christchurch (NZ); Kishore Mehrotra, Christchurch (NZ); Douglas Andrew McConnell, Christchurch (NZ); Ian Vince McLoughlin, Christchurch (NZ); Iain Murdoch Pow, Christchurch (NZ); Thomas Gregory Scott, Christchurch (NZ); David Ian Spalding, Christchurch (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/523,952

(22) PCT Filed: Aug. 8, 2003
(86) PCT No.: PCT/NZ03/00176

§ 371 Date: May 30, 2006

(30) Foreign Application Priority Data
Aug. 8, 2002 (NZ) 520650

(51) Int. Cl. H04Q 7/20

(52) U.S. Cl. 455/450; 455/509

(57) ABSTRACT

A communications system including a plurality of base station transceivers linked by some means over which the base station transceivers communicate, a plurality of mobile transceivers adapted to communicate via the base station transceivers using macrodiversity, and wherein the mobile transceivers are further adapted to control allocation of system resorces to enable communication.

### FIELD OF THE INVENTION

The present invention relates to a radio communications network or system to facilitate mobile communications between users. The invention also relates to a range of techniques implemented in the system.

### BACKGROUND TO THE INVENTION

In traditional cellular radio networks, the existing cellular structure and protocols results in a system that is difficult to set up and maintain, reconfigure as necessary, and expand upon. While this can be acceptable for larger telecommunications providers with a sufficient income from a large customer base, it provides a significant barrier to smaller entities implementing a small area radio communications cellular network.

### SUMMARY OF THE INVENTION

In one aspect the present invention comprising communications system including: a plurality of base station transceivers linked by some means over which the base station transceivers communicate; a plurality of mobile transceivers adapted to communicate via the base station transceivers using macrodiversity, wherein the mobile transceivers are further adapted to control allocation of system resources to enable communication.

Preferably, the radio communication system, and the protocol for carrying out communications on the system, provide an infrastructure to facilitate local area mobile communications, such as in a business campus or the like. Using the mobile transceivers to control system resource allocation, such as use of base stations and channels, enables a self organising communication structure which is adaptable to changing internal and external parameters.

Preferably, the base-station transceivers can communicate with each other over either a local area or wide area network, independently of the radio network or system. The LAN or WAN could be a wired network such as an Ethernet, or a radio network. The LAN or WAN could be shared with existing services.

Preferably, the protocol for communicating from one mobile transceiver to another broadly involves: broadcasting a packet from the source mobile to all base stations in range of the terminal, forwarding the packet over the local/wide area network to a terminal specified base station where diversity combining takes place, forwarding the packet on to a primary destination base station via the network, the primary destination base station, in turn, forwarding copies of the packet to one or a plurality of selected secondary destination base stations and radio-transmitting the same message from the primary and secondary destination base stations to the receiving mobile, using a TDMA scheme. The protocol also specifies how the mobile terminals select base stations and TDMA channels, to provide terminal driven (as opposed to base station driven) handover and macrodiversity.

In another aspect the present invention may be said to consist in a transceiver station adapted to form part of a radio communication system, wherein the communications system implements: a plurality of other similar transceiver stations that are interconnected by a network, mobile terminal controlled handover, and macrodiversity.

In another aspect the present invention may be said to consist in a mobile terminal adapted to operate in a communication system, wherein the communication system implements: a plurality of transceiver stations that are interconnected by a network, mobile terminal controlled resource allocation, and macrodiversity.

In broad terms in another aspect the invention comprises a method of communicating over communication system including a plurality of mobile transceivers and a plurality of base station transceivers where the base station transceivers are linked together by some means including the steps of: transmitting a signal in the form of packets from a transmitting mobile transceiver, each packet including information identifying a receiving mobile transceiver and at least one destination base station transceiver, receiving the packet(s) at at least one receiving base station transceiver, forwarding the packet(s) to the at least one destination base station transceiver, the destination base station transceiver transmitting the packet(s) to the receiving mobile transceiver, and wherein at least one of the receiving base station transceiver and the receiving mobile transceiver uses macrodiversity, and wherein the mobile transceivers control allocation of system resources.

In broad terms in another aspect the invention comprises a method of estimating a transition in a signal including the steps of: sampling an incoming signal, comparing the sample levels in a first group of samples with the sample levels in a second group of samples, comparing the sample levels of samples within the first group of samples, comparing the sample levels of samples within the second group of samples, comparing the sample level of a middle sample with an adjacent middle sample where the middle samples are between the first group of samples and the second group of samples, and estimating a transition point in the signal from the comparisons.

Preferably the method includes continuously taking samples, and a continuous sliding window of six samples is analysed. The first group is the first two samples, the last group is the fifth and sixth samples, and the middle segments are the third and fourth segments respectively. The transition point is estimated to be between the third and fourth samples if they are different, the first and second samples are the same, the fifth and sixth samples are the same, and the first and second samples are different to the fifth and sixth samples.

In broad terms in another aspect the invention comprises a circuit for detecting a transition in a signal, the circuit adapted to: sample an incoming signal at at least twice the bit rate of the incoming signal, compare the sample levels in a first group of samples with sample levels in a second group of samples, compare sample levels of samples in the first group, compare sample levels of samples in the second group, compare the sample level of a middle sample with an adjacent middle sample where the middle samples are between the first and second groups, and from the comparisons output an estimate of a transition point in the signal.

In broad terms in another aspect the invention comprises a communication system that carries out synchronisation between communicating transceivers by sampling an incoming signal at at least twice the bit rate of the incoming signal, comparing the sample levels in a first group of samples with sample levels in a second group of samples, comparing sample levels of samples in the first group, comparing sample levels of samples in the second group, comparing the sample level of a middle sample with an adjacent middle sample where the middle samples are between the first and second groups, and from the comparisons output an estimate of a transition point in the signal.

In broad terms in another aspect the invention comprises method for synchronising the clocks of a first node and a second node in a network including the steps of: at a first time according to the clock of the first node sending a first synchronisation message from the first node to the second node, at a second time according to the clock of the second node sending a second synchronisation message from the second node to the first node, determining a first difference as the difference between the time on the first clock when the first message was sent and the time on the second clock when the first message was received, determining a second difference as the difference between the time on the second clock then the second message was sent and the time on the first clock when the second message was received, determining a clock error as the average of the difference between the first and second differences, and adjusting the clock of either the first node or the second node by the clock error.

Preferably, to assist in determining the clock error, the time of receipt of the first message at the second node, and the time of receipt of the second message at the first node are recorded. After the first node has received the second message, a subsequent third message is then sent from the first node to the second node that contains the time of receipt of the second message at the first node. In this manner, the second node contains all the time of receipt information to determine clock error. Preferably clock synchronisation occurs by adjusting one of the nodes' clocks by the clock error, to match the other node's clock.

Preferably, prior to the above method taking place, an initial coarse clock adjustment is made by sending a request from the second node to the first node, upon receiving the request at the second node, sending the second node's current clock reading back to the first node, and then adjusting the second node's clock to the current clock reading received from the first node.

Preferably, the first node is a master node, and the second node is a slave node.

In an alternative aspect of the method, the second synchronisation message is sent at a different time according to the second node's clock, than the time the first message was sent according to the first node's clock. The time between sending the first message from the first node, and receiving the first message at the second node is calculated (T2). Similarly the time between sending the second message from the second node, and receiving the second message at the first node is calculated (T1). T1 is subsequently sent from the first node to the second node, and the error calculated from (T1-T2)/2.

In broad terms in another aspect the invention comprises a network including a first node with a first clock and a second node with a second clock wherein to synchronise the first and second clocks: the first node is adapted to send a first synchronisation message to the second node at a first time according to the clock of the first node, the second node is adapted to send a second synchronisation message to the first node at a second time according to the clock of the second node, one node is adapted to determine a first difference as the difference between the time on the first clock when the first message was sent and the time on the second clock when the first message was received, one node is adapted to determine a second difference as the difference between the time on the second clock then the second message was sent and the time on the first clock when the second message was received, one node is adapted to determine a clock error as the average of the difference between the first and second differences, and adjusting the clock of either the first node or the second node by the clock error.

Preferably, to assist in determining the clock error, the time of receipt of the first message at the second node, and the time of receipt of the second message at the first node are recorded, at the respective nodes. After the first node has received the second message, a subsequent third message is the sent from the first node to the second node that contains the time of receipt of the second message at the first node. In this manner, the second node contains all the time of receipt information to determine clock error.

Preferably clock synchronisation occurs by adjusting one of the nodes' clocks by the clock error, to match the other node's clock. It will be appreciated that the first node could carry out the error calculation and clock adjustment.

Preferably, prior to the above method taking place, an initial coarse clock adjustment is made by sending a request from the first node to the second node, upon receiving the request at the second node, sending the second node's current clock reading back to the first node, and then adjusting the second node's clock to the current clock reading received from the first node.

Preferably, the first node is a master node, and the second node is a slave node.

In an alternative embodiment of the network, the second synchronisation message is sent at a different time according to the second node's clock, than the time the first message was sent according to the first node's clock. The time between sending the second message from the second node, and receiving the first message from the first node is calculated (T2). Similarly the time between sending the first message from the first node, and receiving the second message from the second node is calculated (T1). T1 is subsequently sent from the first node to the second node, and the error calculated from (T1-T2)/2.

In broad terms in another aspect the invention comprises a communication system utilising a local area network, the network including a first node with a first clock and a second node with a second clock wherein to synchronise the first and second clocks: the first node is adapted to send a first synchronisation message to the second node at a first time according to the clock of the first node, the second node is adapted to send a second synchronisation message to the first node at a second time according to the clock of the second node, one node is adapted to determine a first difference as the difference between the time on the first clock when the first message was sent and the time on the second clock when the first message was received, one node is adapted to determine a second difference as the difference between the time on the second clock then the second message was sent and the time on the first clock when the second message was received, one node is adapted to determine a clock error as the average of the difference between the first and second differences, and adjusting the clock of either the first node or the second node by the clock error.

Preferably, to assist in determining the clock error, the time of receipt of the first message at the second node, and the time of receipt of the second message at the first node are recorded, at the respective nodes. After the first node has received the second message, a subsequent third message is then sent from the first node to the second node that contains the time of receipt of the second message at the first node. In this manner, the second node contains all the time of receipt information to determine clock error. Preferably clock synchronisation occurs by adjusting one of the nodes' clocks by the clock error, to match the other node's clock. It will be appreciated that the first node could carry out the error calculation and clock adjustment.

Preferably, a prior to the above method taking place, an initial coarse clock adjustment is made by sending a request from the second node to the first node, upon receiving the request at the second node, sending the second node's current clock reading back to the first node, and then adjusting the second node's clock to the current clock reading received from the first node.

Preferably, the first node is a master node, and the second node is a slave node.

In an alternative embodiment of the system, the second synchronisation message is sent at a different time according to the second node's clock, than the time the first message was sent according to the first node's clock The time between sending the second message from the second node, and receiving the first message from the first node is calculated (T2). Similarly the time between sending the first message from the first node, and receiving the second message from the second node is calculated (T1). T1 is subsequently sent from the first node to the second node, and the error calculated from (T1-T2)/2.

In broad terms in another aspect the invention comprises a method of allocating communication resources for a mobile terminal in a communication system that utilises a base station network including the steps of: identifying uplink channel usage in the range of the mobile terminal, identifying one or more spare uplink channels, and transmitting over the one or identified channels without negotiation with the base station.

The method may further include identifying a new uplink channel for transmission to avoid interference. Preferably interference is detected before total failure using properties of macro diversity.

In broad terms in another aspect the invention comprises a method of allocating communication resources for a mobile terminal in a communication system that utilises a base station network including the steps of: identifying downlink channel usage in the range of the mobile terminal, identifying one or more spare downlink channels, and instruction a transmitting mobile terminal to utilise the identified channel(s) for transmission.

The method may further include identifying a new downlink channel for transmission to avoid interference. Preferably, interference is detected before total failure using properties of macro diversity.

The system may be further adapted to identify a new uplink channel for trasmission to avoid interference. Preferably interference is detected before total failure using properties of macro diversity.

In broad terms in another aspect the invention comprises a method of transmitting a data stream from a first mobile terminal to a second mobile terminal over a communication system including the steps of: identifying one or more spare channels for the downlink to the second terminal, separating the data stream into multiple portions according to the number of identified spare channels, and transmitting the multiple portions over the spare channels to the second terminal.

In broad terms in another aspect the invention comprises a communication system as wherein at each new time slot in a TDMA transmission the transmit or carrier frequency may change.

In broad terms in another aspect the invention comprises a communication system in which data is transmitted in packets wherein before transmitting data a transmitter provides a distinction between payload sequences and synchronisation sequences in the signal by scanning the payload sequence to determine any portions of the sequence that could be detected as a synchronisation sequence, introducing errors into the portions of the payload sequence, and wherein the introduced errors are within an error correction capability of a payload error correction code.

In broad terms in another aspect the invention comprises a communication system including at least one register that can communicate over the communication system and adapted to store at least a portion of the network configuration information of the communication system.

Preferably, the registers are actually implemented in terminals the same or similar as the mobile terminals, to provide a distributed register system. The registers can themselves be mobile, or stationary. The location of each register is stored in each mobile terminal, so they can contact the registers to request channel and station allocations prior to making a call. If a register does not contain the required information, it will forward the request to another register.

In one possible embodiment, the register functionality is implemented in one or more mobile terminals.

Preferably, the registers are actually implemented in terminals the same or similar as the mobile terminals, to provide a distributed register system. The registers can themselves be mobile, or stationary. The location of each register is stored in each mobile terminal, so they can contact the registers to request channel and station allocations prior to making a call. If a register does not contain the required information, preferably it is adapted to forward the request to another register.

In one possible embodiment, the register functionality is implemented in one or more mobile terminals.

### BRIEF LIST OF FIGURES

Preferred embodiments of the invention will now be described with reference to the following Figures, of which;

FIG. 1 is a schematic diagram of a preferred embodiment of a radio communication system according to the invention,

FIG. 2 is a schematic diagram of a preferred embodiment of an interconnection of two such radio systems,

FIG. 3 is a schematic diagram of the diversity protocol used in the radio communication system,

FIGS. 4a, 4b and 5 are schematic diagrams illustrating the handover process as terminals move through the communication system,

FIGS. 6a and 6b are schematic diagrams of the slot and frame structure of the communication system's TDMA scheme,

FIG. 7a shows a transition in a noise free bitstream,

FIG. 7b is a truth table for the transition estimation method,

FIG. 7c shows a transition in a noisy bitstream,

FIG. 8 is circuit diagram of a preferred embodiment of the circuit for implementing the transition estimation method,

FIG. 9a is a map of transition estimations that produce a timing output in the circuit shown in FIG. 8,

FIG. 9b is a Boolean expression representing the map,

FIGS. 10a to 10c show various node configurations in a network for clock synchronisation,

FIG. 11a is a timing diagram showing a method of clock initialisation for a new node on a network,

FIG. 11b is a timing diagram showing a method of coarse clock synchronisation between two nodes on a network,

FIG. 12 illustrates various 14 bit window samples of an bitstream that are altered to provide distinction from a synchronisation word,

FIG. 13 is a schematic diagram indicating the mechanism by which a mobile terminal queries the location of another terminal using terminal base registers (TBRs),

FIG. 14 is a table of typical information contained in a TBR, and

FIG. 15 is a schematic diagram of the TBRs in a multiple fleet communication system.

### DETAILED DESCRIPTION OF THE PREFERRED EMBODIMENTS

1. Overall System—Wireless Network

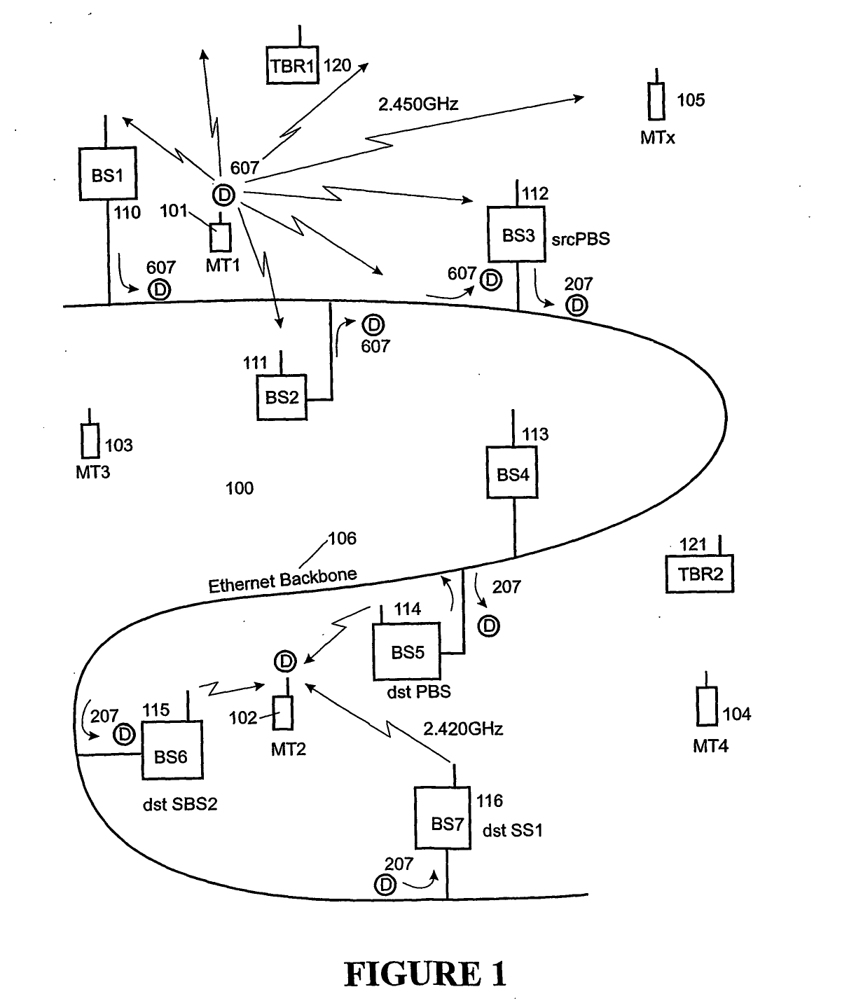

FIG. 1 shows a preferred embodiment of a small area radio network 100 according to the invention, suitable for operation by a private or public entity. It will be appreciated that FIG. 1 is a schematic representation, and does not necessarily represent the physical layout. Further it will be appreciated that only a small number of components are shown for explanation purposes. A person skilled in the art would readily understand that the system could be expanded, as required. When referring to the network or system 100 it will be appreciated that this term covers non physical elements such as protocols, configuration details and the like, as well as the physical components and connections.

The radio system 100 includes a plurality of mobile transceivers or terminals 101-105 (labelled MT1-MTx) that users of the system utilise to carry out personal communications between each other. The system 100 also includes a plurality of base station transceivers 110-116 (labelled BS1-BS7) interconnected by a network backbone, such as a WAN or LAN. In the preferred embodiment a LAN 106 is used. In a possible embodiment, the LAN is an Ethernet, in which each base station 110-116 is connected to an Ethernet backbone. Alternatively, any type of suitable, hardwired or radio LAN could be utilised. The network could be shared with existing services.

One or more terminal base registers, eg TBR1 120 and TBR2 121, store for each mobile 101-105 terminal a list of base stations and channels selected by the respective mobile terminal to be used to set up a new call. Each mobile terminal 101-105 updates its associated TBR entry independent of any other mobile terminal 101-105. The system resource specified in a TBR entry should not be in use at the time the entry is created or subsequently updated. The TBRs 120, 121 can be independent mobile devices in communication with the base stations 110-116. Alternatively the TBR functionality can be implemented in one or more of the mobile terminals 101-105.

The system 100 is adapted to implement a macrodiversity communication protocol utilising a mobile terminal controlled, self modifying cell structure. Preferably, the system transmits on a single uplink frequency using TDMA, and transmits on a single downink frequency using TDMA, although this is not essential. Other transmission schemes, such as CDMA or FDMA could readily be employed instead. Broadly, the full duplex communication takes place between two mobile terminals by: broadcasting an outgoing message from the transmitting terminal, which is received by one or more base stations, forwarding the message over the LAN to a diversity combining base station previously selected by the terminal, forwarding the combined message to a primary destination base station previously selected by the receiving terminal, forwarding the message to two secondary base stations previously selected by the receiving terminal, and transmitting the message from the destination base stations to the receiving mobile terminal. The system is adapted to send both voice and data traffic, as required, between mobile terminals.

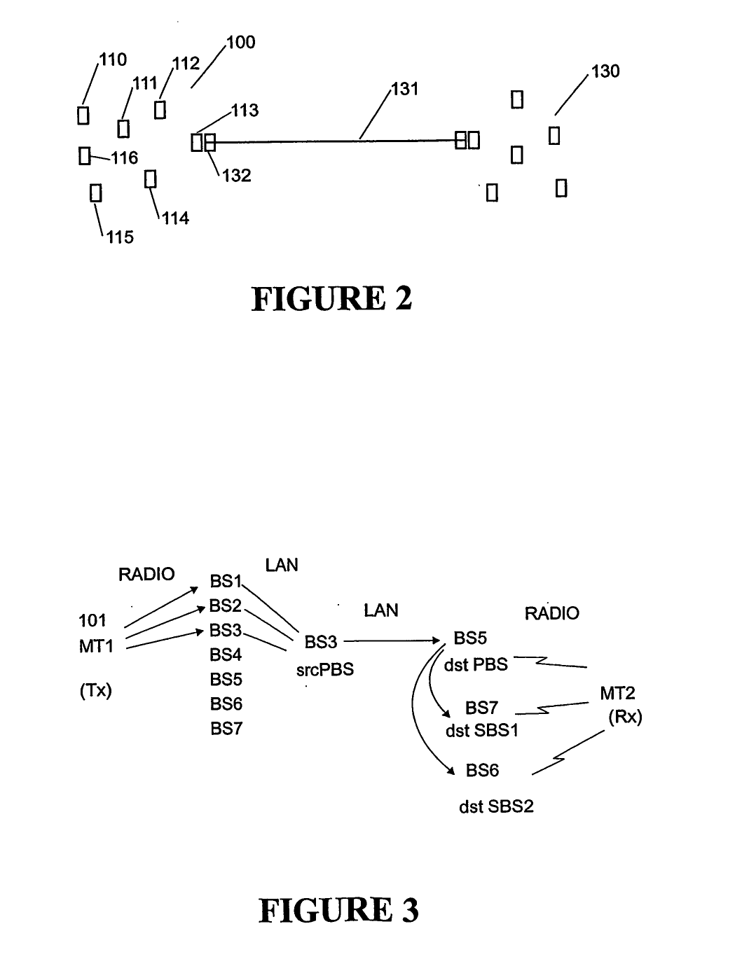

The system 100 can also be adapted to interconnect with another network 130, as shown in FIG. 2. The interconnection 131 may take place by either a radio link, or a wired link such as a PTSN, Internet or other transmission link. For example, one of the base stations, eg 113 can be interconnected to a PABX 132 headend that couples the system 100 to a standard telephone network 131. Traffic on the system 100 can then be routed, via the PABX 132, over the telephone network 131 to a similar system 130, connected to the telephone network 131 in a similar manner.

The system 100 may also be adapted to independently carry traffic for-two or more services, such as for fire and police services. This can be achieved by implementing terminal base registers as described later on. The system can also be adapted so that the traffic for one service becomes available to the other, and vice versa, if required.

System Protocol—Terminal Controlled Channel Allocation

As mentioned with reference to FIG. 1, the system 100 consists of a number of mobile terminals 101-105 and a network of base stations 110-116. Preferably, the base stations are connected into a network 106 with substantially loss-less media so that the base stations 110-116 can communicate with each other substantially without loss.

Each base station 110-116 is capable of transmitting and receiving (simultaneously) data to and from terminals 101-105. Communication between the base station and terminals are divided into time slots and can support multiple terminals through TDMA. There is no restriction on the type of access scheme. CDMA or FDMA can be applied to the system equally. For the rest of this document, channel allocation refers to the mechanism in which the time slot, or spreading code, or frequency band or any equivalent access scheme is selected.

In a given communication system, there exists a quality of service (QoS) measure that determines whether a given communication link can support a given type of service for example voice traffic, data traffic and the like. This quality measure encompasses not only signal strength (SNR) but also factors such as delay, availability, etc. This quality measure is highly dependent on the type of service. For example, voice traffic can tolerate bit errors but not delay, while file transfer can tolerate high delay but has to be error free. In conventional systems, the type of service, and hence the quality required, are encoded in the data packet and each node in a network is made aware of the type of service required. For example, a voice packet will be given higher priority in a queue so that it is serviced before a data packet, whereas a data packet will contain higher level of error correction/detection coding and local acknowledgment. The present system 100 preferably provides a uniform service across the network and places no distinction on the type of services in the base stations. The base stations doe not know the quality of service required by the mobile terminals. This system provides a different grade of service at the mobile terminal only.

In addition, to differentiate services in the terminals 101-106, the controls in the base station network are further reduced by not associating a terminal with any particular base station. This differs from a cellular phone system where a phone is registered to a local base station. In the present system 100, a terminal 101-106 selects which base stations 110-116 and which channels the terminal will use, without negotiating with the base stations concerned. This means that there is no terminal to base station handshake/negotiation during handoff.

The base stations 110-116 can be seen as providing a pool of resources measured in channels/area With no load in a typical system 100 according to the invention, a base station provides 32 time slots in each direction (uplink/downlink). When multiple base stations 110-116 are used, depending on the amount of traffic in adjacent areas, the number of useable channels may vary. A receiver 101-105 at any location in the system, is capable of receiving data on all 32 time slots. Some of which may be other terminal's traffic, some of which are unused, and some of which could have interference. A terminal 101-105 can distinguish the three different types of time slots, and then make a decision on utilising some of the slots without negotiating with the base stations 110-116. Furthermore, the terminals 101-105 in a given local area could be made to co-operate with each other by implementing certain restrictions on how the free channels are to be allocated, again, without negotiation with the base stations 110-116.

System Protocol—Transmission Scheme

The communication protocol will be explained in more detail with reference to a call made between two mobiles, as shown in FIG. 1, and more particularly in FIG. 3. These figures illustrate an example of a forward communications “link” between a transmitting mobile, eg MT1 101, and a receiving mobile, eg NM 102, in schematic form. It will be appreciated that transmission may take place in opposite directions simultaneously, as it normally would do in full duplex transmissions.

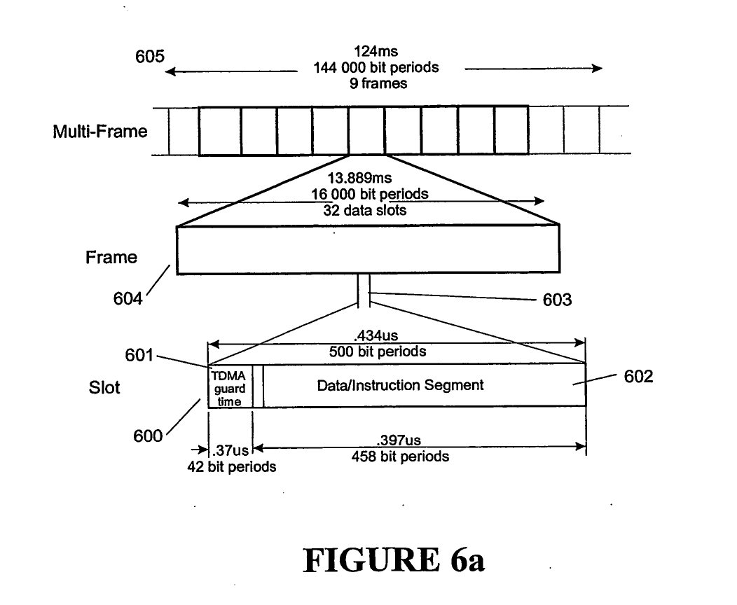

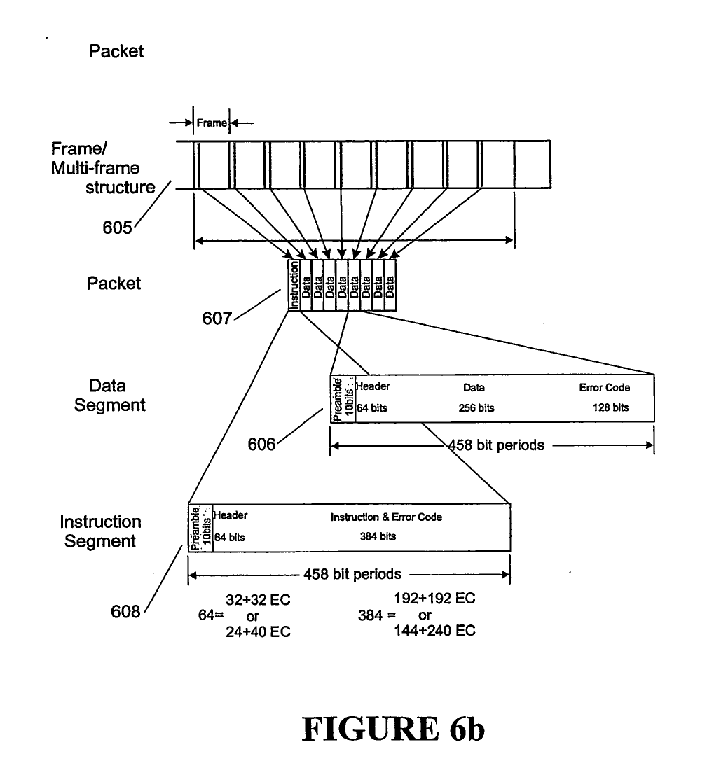

When a voice or data call is initiated from MT1 101 to MT2 102, MT1 will retrieve the source and destination base stations, and associated uplink and downlink time slots from one or more TBRs 120, 121 as will be described later on. In this case MT1 has selected BS3 112 as its source primary base station (srcPBS), while MT2 102 has selected BS5 114 as its destination primary base station (dstPBS), and BS7 116, BS6 115 as its first and second destination secondary base stations (dstSBS1 and dstSBS2) respectively. The channel and base station selection process is described later on. MT1 101 then sets up a call with MT2 102 by broadcasting (on the uplink frequency) a packet 607 (in the selected time slot over 9 frames) to all base stations 110-116 within radio contact. For example, as shown in FIGS. 1 and 3, base stations BS1 110, BS2 111, BS3 112 receive the packet 607, via the radio uplink. Details of the packet 607 structure will be described with reference to FIGS. 6a and 6b. The packet 607 contains information identifying the source primary base station srcPBS 112 for the transmitting mobile MT1 101, and the destination primary base station dstPBS 114, dstSBS1 116, and dstSBS2 115 for the receiving mobile MT2 102. The packet 607 also includes information on the time slot each base station 112, 114, 115, 116 should use, as selected by the respective mobiles MT1 101 and MT2 102. All the radio stations that receive the packet 207, extract the ID of the srcPBS 112, and each forward the packet 607, over the Ethernet, to the srcPBS 112. The srcPBS 112 may or may not also receive the packet 607 directly from MT1 101 via radio. If it does not, it is likely that MT1 101 will reselect its srcPBS at the next opportunity. This scheme provides macrodiversity in the uplink.

The source primary base station srcPBS 112 then performs diversity combining on the segments comprising the data packet 607, to reduce the error probability. It then forwards the data packet 207 over the Ethernet 106 to the destination primary base station dstPBS 114, which in turn forwards the data packet to dstSBS1 116 and dstSBS2 115. The dstPBS 114, dstSBS1 116 and dstSBS2 115 then all transmit the same data packet 207, in their three respective time slots previously selected by MT2 102. This provides time and space macrodiversity on the downlink. MT2 102 receives three versions of the data packet 207 transmitted on the downlink frequency in the three different time slots, and performs diversity combining to reconstruct the data packet 207. MT2 102 receives a multitude of data packets in this manner, representing the original voice message or data transmitted from MT1 101. The message or data can then be reconstructed by MT2 102 and relayed to the user of MT2. As the communication is full duplex, a reciprocal link is set up between MT2 102 and MT1 102 to enable communication in the other direction. The source primary base station and destination primary and secondary base stations srcPBS, dstPBS, dstSBS1 and dstSBS2 in the reciprocal link will, in general, differ from those in the forward link. It will be appreciated that addition to time and space diversity provided by the downlink transmission of packets from multiple base stations 110-116, each base station may also have multiple antennae to implement an additional antenna diversity scheme.

System Protocol—Handoff

The system utilises macro-diversity to improve performance by
1. increasing resistance to deep fades
2. providing multiple (redundant) path for signals

In a conventional system, when a mobile terminal moves to a different cell, a process in which the signal is switched from an original base station to a new base station has to take place. This generally includes allocating bandwidth and transferring existing call information to the new base station.

In the present system 100, there is no explicit handoff from one base station to the other. At any instant in time, the terminal's transmission is received by multiple base stations ie macro-diversity. Since there is no negotiation required for a base station to receive a packet, there is no handoff process required in the uplink direction.

A terminal eg MT1 101 selects the uplink and downlink channels it will use by monitoring the traffic it receives. By selecting channels that are not currently in use, the terminal MT1 101 maximises the chance of the packet being received by at least one base station.

As described in the previous section, the base station only forwards packets and each packet contains the complete channel information. This means that the terminal MT1 101 can change its downlink channels as fast as once every packet, again, without the overhead of negotiating with base stations.

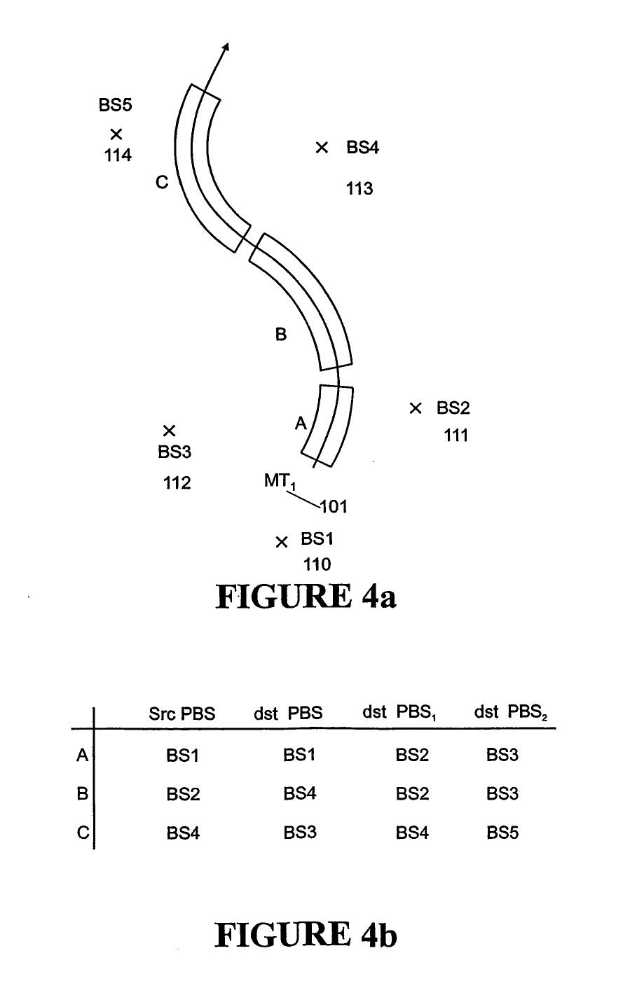

FIG. 4a shows an example of a mobile terminal MT1 101 moving through a network consisting of base stations BS1 110 to BS5 115. As MT1 101 moves from region A, through B to C, its selection of base station for the downlink is shown in the table of FIG. 4b. As the mobile terminal moves out of region A into B, it removes the weakest base station, BS1 110, from the list and adds BS4 113 into the list as MT1 moves towards BS4 113.

The selection of channels (for example one of the 32 TDMA channels) can be updated at the same time. A channel can be considered as being a unique combination of a base station 110-116 and one of the 32 TDMA channels, so that one can distinguish between slot 24of BS1 110 and slot 24 of BS2 111.

Unlike the conventional cell structure where the coverage area of the system is divided into a distinct set of cells each assigned to a base station, the mobile terminals 101-105 of the present system 100 utilise multiple base stations 110-116 simultaneously. It can be considered that terminal eg MT1 101 assigns a set of base stations eg BS1 110-BS3 112, to form a ‘cell’ around the mobile terminal MT1 101 that is best suited for the current environment as perceived by the mobile terminal. This characteristic is described further in the collective intelligence description of the system and is sometimes referred to as a self-organising cell structure in this document.

System Protocol—Interference Avoidance

One advantage of using macro-diversity is that the communication link is less likely to fail totally. For example, if a system utilises three times diversity, instead of receiving vs not receiving, the diversity'system now has receive three times the data, receive two times the data, receive the data once, and not receiving.

In a conventional system, multiple transmission in the same time-frequency slot will result in total loss of data. For a system with diversity, interference can be tolerated as the signals from interfering terminals are likely to be received by some but not all base stations in the local area. This degradation in the number of diversity channels utilised is used as an early indication of a potential problem and the terminals can take actions in avoiding this interference.

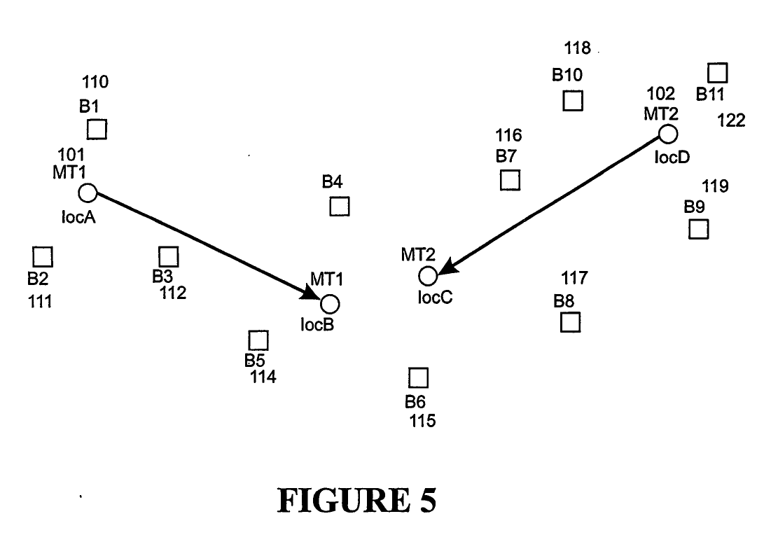

Consider the system shown in FIG. 5, consisting of two terminals MT1 101 and MT2 102 and the base station network B11 10 to B11 122. The mobile terminals MT1, MT2 independently select channels, that each comprise a time slot and a base station, for downlink reception. For example, MT1 101 at location A may select [B1 slot11], [B2 slot 12] and [B3 slot 13] as the three downlink diversity receptions. In a remote location, MT2 102 at location D could select [B9 slot11], [B10 slot12], and [B11 slot 14]. With location A and location B sufficiently isolated, both mobile terminals can make use of the same time slot without producing interference on each other.

Now assume that MT1 101 moves from location A to location B, and at the same time, MT2 102 moves from location D to location C. Each mobile terminal MT1 101, MT2 102 makes independent channel and base station selections as it moves, preferably, in the way described in the handoff section. As the mobile terminals MT1 101, MT2 102 move into proximity of each other they start to share some of the base stations. For example, MT1 uses [B4 slot11], [B5 slot 12], and [B6 slot 13] while MT2 uses [B6 slot 11], [B7 slot12], and [B8 slot 14] sharing B6. At the first instance when this particular channel combination occurs, each mobile terminal has only one times diversity without interference. ie MT1 from [B6 slot 13] and MT2 from [B8 slot 14]. Slots 11 and 12 would have two competing downlink transmissions in the local area. However, since MT1 is closer to B4 and B5 than to B7 and B8, each terminal would still have more than one times diversity. This provides continuity in the reception during interference.

The above mechanism describes how interference can be detected as soon as it occurs in the terminal, and shows that interference does not result in packet loss due to the use of diversity reception. The mobile terminals 101 and 102 further implement methods in which a new non-interfering channel (base station and time slot) can be selected and used in place of the original channel to actively avoid interference.

System Protocol—Frame Structure

FIGS. 6a and 6b illustrate the TDMA frame structure in the system. A segment 600, containing either instruction, voice or data information, has a TDMA guard time 601 (42 bit), and a data/instruction segment 602 (458 bit). The segment 600 is transmitted in a 434 microsecond time slot 603. A transmission frame 604 comprises 32 timeslots 603 (at total time of 13.889 milliseconds), providing 32 TDMA channels. A multiframe 605 consists of 9 frames, with an overall time of 125 milliseconds. Each slot in consecutive frame forms one channel in which information can be exchanged between mobile terminals. Referring to FIG. 6b, the information for one packet 607 is spread over nine frames, including eight data segments 606 and one instruction segment 608. In this manner 32 individual information packets 607 can be sent in different respective time slots to provide 32 TDMA channels. It should be noted that the TDMA guard time is not shown in the instruction and data segments 608 and 606 respectively.

2. Fast Symbol Timing System

In a serial digital communications link it is generally necessary to synchronise a local timing clock at the receiving end of the link with the estimated state transitions of the received data symbols, in order to recover the transmitted data from the received symbol sequence by a known method. Where an independent timing signal is not available from the transmitter, as in a typical wireless system, the timing information must be recovered from the received symbol sequence itself. In general, the symbol sequence is corrupted by varying levels of noise which, apart from causing errors in received symbol states, may cause errors in the recovery of timing information, thereby exacerbating the recovered data bit error rate (BER).

It will be apparent to those skilled in the art that the required symbol clock synchronisation accuracy in the receiver for a given BER requirement is dependent on a number of factors including, for example, modulation format, data rate, link bandwidth and minimum received signal-to-noise ratio (SNR). A variety of synchronisation techniques are known, so that the most appropriate method may be selected for a particular combination of such factors. However, known techniques for synchronising a clock to a noisy signal typically require integration of phase-locking information over a period of time that may be unacceptable in some schemes, for example, in a time-division multiple-access (TDMA) scheme, where reliable synchronisation may be required to be attained within a few symbol periods. Existing edge-detection has been found to be susceptible to errors resulting from noise. Furthermore, the presence of DC offset voltage on the received signal prior to quantisation may limit the effectiveness of a synchronising system by causing an excess probability of occurrence of one binary quantised state over the opposite state.

In one embodiment of the present invention, a symbol timing method and circuitry is implemented to assist in synchronising a local timing clock at a receiving end of a transmission link by identifying transitions in incoming data bit streams. More particularly, the method relates to estimation of where a positive to negative, or negative to positive, bit transition takes place in a signal. In general terms, the method involves continuously taking samples of a signal representing a bit stream, and analysing a moving window of the samples using a set of rules to determine if a transition has taken place in the data stream. The method can further involve comparing a suspected transition with several previous transitions to assist in estimating the occurrence transition.

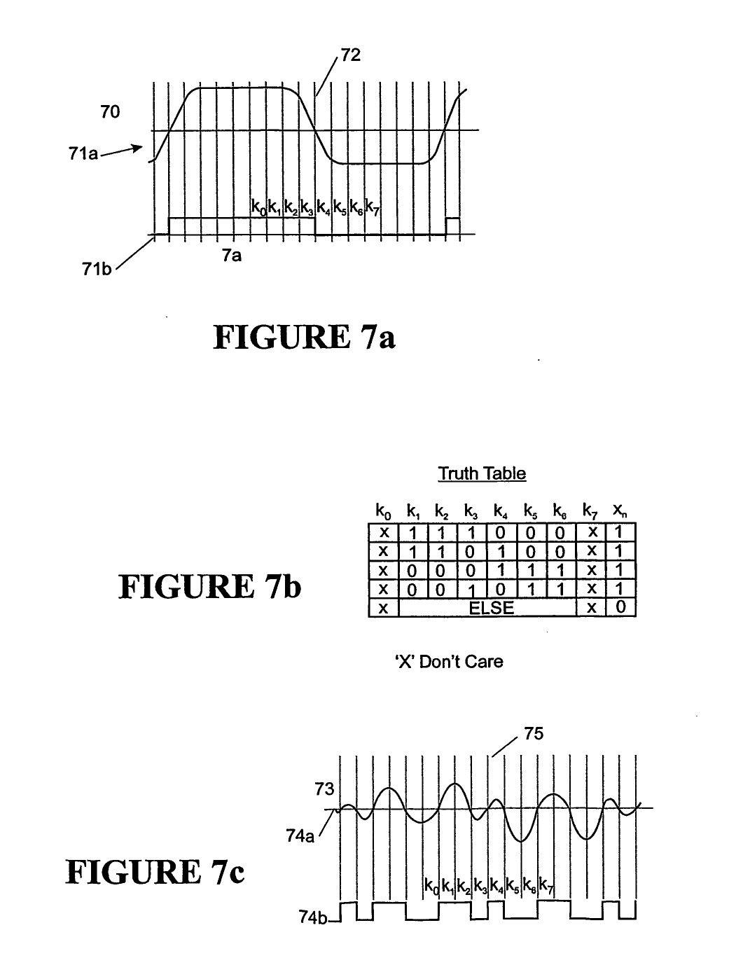

FIG. 7a shows an example bit transition without noise in a bit stream 70, the analogue signal representing the bit stream shown at the top 71a, and the sampled version shown underneath 71b. The preceding and subsequent states need not be of one bit period as shown and may be of any duration for a transition 72 detection to occur. A defined sequence of transitions is preferred for subsequent processing, as will be described. The incoming stream 70 is sampled continuously to produce a sliding window of preferably eight samples k₀ to k₇ (a symbol period), although any suitable number could be used. A valid transition is determined by comparing three samples k₁ to k₆ each side of the centre of a sliding window, such that at any one time six of the eight samples k₀ to k₇ of the window are used for transition identification. Although there are eight samples per bit period in the preferred embodiment, the first and last samples in the period, k₀ and k₇, are not required for the transition detection process.

The truth table in FIG. 7b shows the patterns of sample bits k₁ (leading) to k₆ (trailing) that result in a transition, eg 72, being detected. The states either side of a transition are determined by the samples k₁=k₂ and k₅=k₆, these two matched pairs being of opposite state. However, the effect of noise close to the nominal state transition time is to cause uncertainty in the sample states k₃ and k₄ nearest to the transition so that, for preference, a condition is included that samples k₃ and k₄ must be of opposite state but not dependent on the state of the other samples. The method for detecting a transition is based on this observation. More particularly, in the method bits k₁ and k₂ are compared to determine if they are the same magnitude. Similarly, bits k₅ and k₆ are compared to determine if they are the same magnitude, and of an opposite state to k₁ and k₂. Then bits k₃ and k₄ are compared to see if they have different magnitudes. If k₁=k₂ and k₅=k₆, they are of opposite sign, and k₃<>k₄, then it is determined that a transition has taken place between k₃<>k₄. The truth table in FIG. 7b represents the resulting Boolean logic generated from these rules.

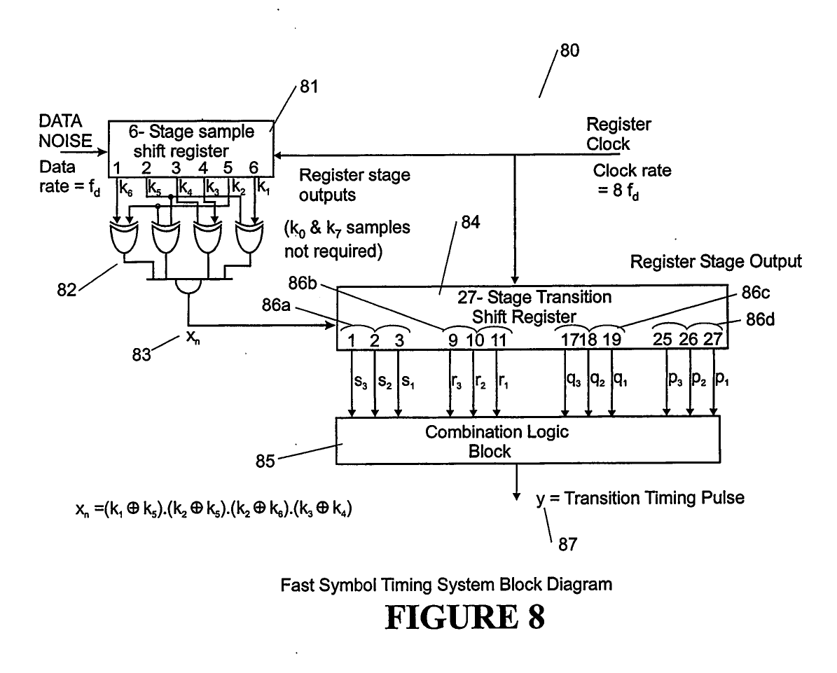

FIG. 7c is representative of a data signal 73 having a very high level of noise, again with the analogue signal representing the bitstream being shown at the top 74a, and the sampled version underneath 74b. It will be apparent that according to the method, a transition would be detected at the desired point 75 in the waveform. More particularly, it can be seen that sampled bits k₁,k₂ are the same, bits k₅,k₆ are the same but an opposite state, and bits k₃,k₄ are different. Although the waveforms shown in FIGS. 7a and 7c indicate negative-going transition detection, the operation of the system is identical for positive-going transition detection. It should be noted that the order in which bits are compared is not relevant and that in the circuit shown in FIG. 8 bit comparison is simultaneous.

The rate at which data samples are taken to determine a transition in the received data must be greater than the received data rate. In the embodiment described the middle six of eight samples are used to determine a transition. This means that the sample rate must be at least three times the data rate so that the six samples do not straddle more than two data bits when the transition is in the middle of the samples. The greater the sample rate the more accurate the transition sampling. However the greater the sample rate the more computationally expensive sampling becomes. If the sampling rate is too great then transitions may be detected where none occur. To provide useful results the data must be sampled at at least twice the data bit rate.

The block diagram of FIG. 8 shows a circuit 80 for carrying out the method of the invention. The circuit includes a six stage sample shift register 81, for continuously obtaining a six sample window k₁ to k₆ of the signal representing the bit stream, eg 73. The register 81 samples the signal at the register clock rate, which is preferably greater than the data bit rate. In the embodiment shown in FIG. 8 the register clock rate is eight times the data bit rate. The samples are shifted continuously at the clock rate through successive stages of the sample shift register 81 and passed through successive output stages 1-6 to combinational logic 82 so as to effect a sample pattern recognition process in accordance with the truth table shown in 7b. In particular, the logic includes 4 XOR gates and an AND gate which produce a logical high output xₙ when one of the bit state combinations set out in the truth table exist. More particularly, the logic generates a transition detection pulse xₙ at the output 83 to indicate both positive-going and negative-going transitions in the incoming bit stream, eg 73.

It will be apparent to those skilled in the art that the accuracy with which a state transition time phase may be estimated in the presence of noise depends on the length of the symbol sequence over which the estimate is made, using known techniques for filtering random timing variations, or jitter. According to the present invention there is provided a means for filtering the jitter by a causally-related pattern matching method. More particularly, a decision is made as to whether or not an estimated transition (based on the above rules) is a transition based on the position of the estimation relative to the position of previously estimated transitions.

Referring to the block diagram in FIG. 8, the transition detection pulses Xn generated by the combinational logic 82 are sequentially shifted through a transition shift register 84 at the same register clock rate as that used for the sample shift register 81. The transition shift register 84 stores transition detection pulses xₙ and the relative time phases of the sequence of transition detection pulses can be compared by processing a selected set of transition shift register 84 outputs 1-27 in a combination logic block 85. Preferably a 32 bit shift register is used, in which four blocks 86a-86d of 8 bit sample windows, which are continuously obtained by the sample shift register 81, are sequentially shifted through. A logical high in the shift register indicates an estimated position of a state transition for an 8 bit symbol period. Therefore, the transition shift register 84 usually contains 4 successive estimated transitions, the positions of which are sequentially shifted through the register. It will be appreciated that a larger shift register could be used to analyse further transitions, if required.

As the sampled bits are continuously shifted through the transition register 84, preferably, the first three register outputs 1-3, 9-11, 17-19, 25-27, corresponding to the first three successive time phases for each 8 bit block 86a-86d in the register 84, are compared. In essence, this means that the transitions are analysed as they are shifted into and move through the first three time phases of each 8 bit block 86a-86d in the shift register 84. For the purpose of this description, the values of the transition register outputs, in order from leading to trailing, are designated p₁,p₂,p₃; q₁,q₂,q₃; r₁,r₂,r₃; s₁,s₂,s₃. A new estimated transition xₙ enters the first block 86a of the shift register 84 at S3 and is compared with previous transitions shifting through blocks 86b-86d.

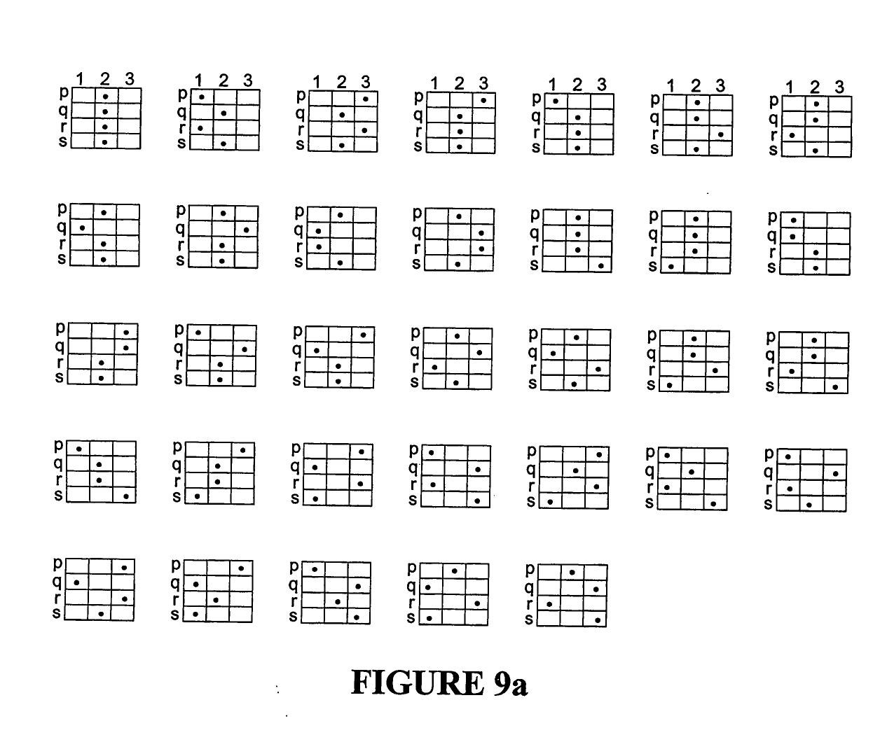

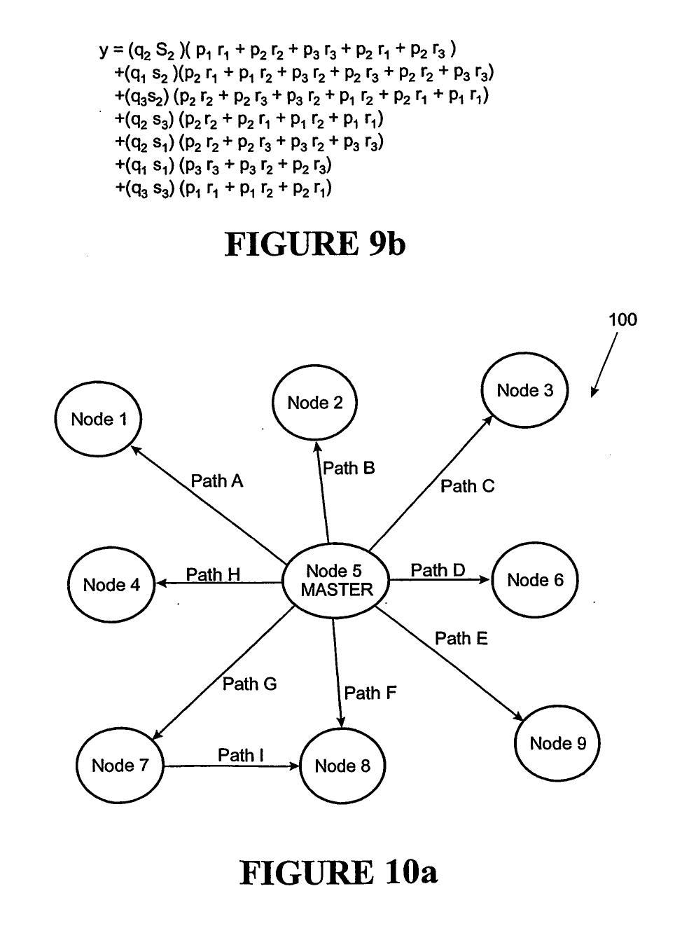

FIG. 9a shows the mapping of these values in accordance with the following preferred set of rules for determining a valid timing estimate, as carried out by the combinational logic block 85:
(1) the phase difference between samples p and r shall be a maximum of 1 sample interval;
(2) the phase difference between samples q and s shall be a maximum of 1 sample interval;
(3) the phase difference between any 2 samples shall be a maximum of 2 sample intervals;
(4) the mean phase of 4 samples shall have minimum deviation from sample phase 2; and
(5) where rule (4) is ambiguous, the trailing sample (s) shall be at sample phase 2.

The resulting transition timing estimate y 87 in accordance with the above rules is represented by the logical expression in FIG. 9b, which the combinational logic block 85 implements. Each time the combination logic block 85 detects that the above rules have been satisfied, it outputs a logical high at y 87, which is a timing pulse that corresponds to the estimated timing in accordance with the transitions that have been analysed. By only looking at the first three time phases in each block, this reduces the risk that a timing pulse might occur more that once a symbol period.

The foregoing set of rules has the advantage of separating the effects of random noise and of excess probability resulting from DC offset in the signal prior to binary quantisation, as may occur, for example, in a radio receiver demodulator circuit. It will be apparent, however, that other rule sets may be employed, as well as other shift register and symbol sequence lengths, according to requirements associated with different system and signal characteristics.

It will be appreciated that the edge detection invention can be used to detect transitions in any type of electronic equipment or system where signal transitions need to be identified for synchronisation purposes. The invention is not restricted to implementation only in the radio communications system described here.

3. Network Timing Protocol

As communications take place between base stations 110-116 over the Ethernet 106 or other network, the clocks of the respective base stations 110-116 can drift out of synchronisation with each other, due to, for example, different initial conditions, drift due to instantaneous jumps in timing, or regular drift due to errors such as the slight frequency difference between the crystals of different stations 110-116. Preferably some method of synchronising the clocks of respective base stations 110-116 across the network is implemented to overcome the difficulties caused during transmission of information across the network when the clocks are out of synchronisation.

A preferred embodiment of a network timing protocol invention, as described below, may be implemented. This protocol can be implemented in the base station network described in this specification, or in any other network in which synchronisation between the clocks of nodes on the network is required. In the general case, the invention relates to nodes on a network, so for the present description the terminology “node” will be used in place of “base station” for generality.

In a preferred embodiment, each base station runs on its own individual 100 MHz crystal that clocks a counter down with a 20 ns period. The counter counts from 21700 down to 0 then resets, thus giving a 434 μs period (one slot time). At this point an interrupt is generated that increments a second counter. This counter counts up, giving the number of slots since the start of a multiframe. At 288 (9 frames*32 slots) the counter resets beginning a new multiframe. Individual frame numbers are currently not measured, nor is the number of slots within a frame. The timing protocol uses the second timer of a DSP, thus leaving the first timer available for BIOS software functionality. The timer has three registers,
The timer count register—this contains the current value of the counter,
The timer period register—this contains the value that will be reloaded into the counter once the terminal count (0) is reached.
The timer control register—this contains turn on/off functionality and a prescaler value set to 2, (20 ns increment).

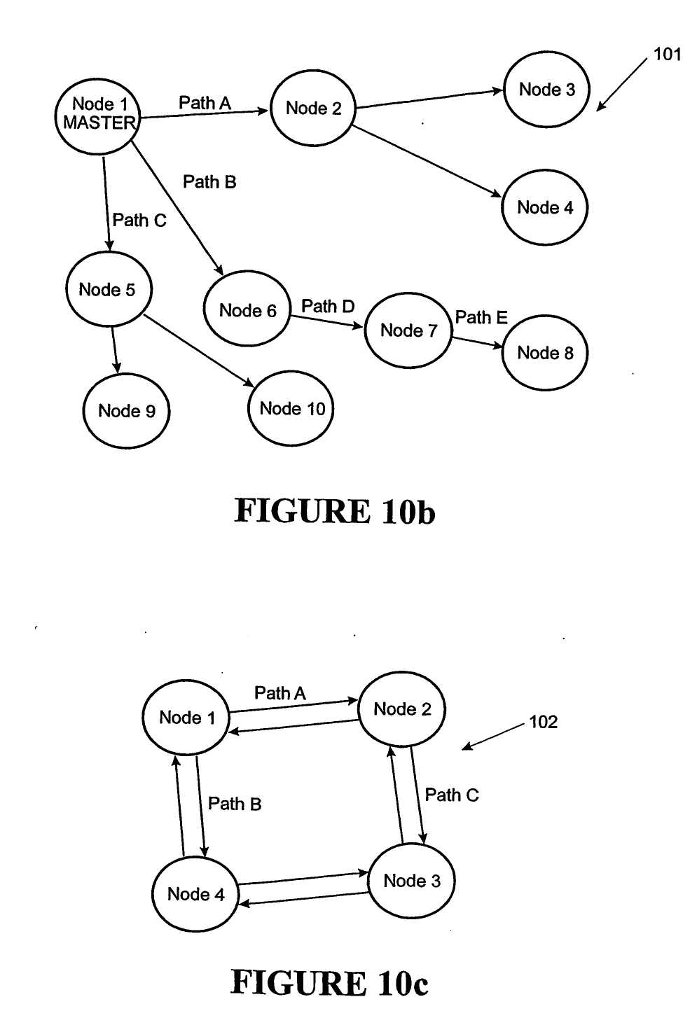

The time synchronisation of two waveforms over the Ethernet is based on simultaneous messaging by two base stations on the full duplex channel. Each of the two nodes sends a packet synchronised with the starting pulse of their waveform. This is at some known point within an allocated slot. Preferably, to implement synchronisation, the nodes can be nominally arranged in one of three configurations as shown in FIGS. 10a, 10b and 10c. It will be appreciated that other configurations could also be used where required. It should be noted that the diagrams represent the synchronisation relationship between nodes, and do not necessarily relate to actual physical or logical network connections. Further, the slave/master designations of the nodes are only are of consequence in relation to synchronisation activities, and, in general, do not necessarily relate to any type of slave/master relationship in relation to network traffic taking place between nodes.

FIG. 10a shows a first possible node configuration 100 in which there is one master node 5 and multiple slave nodes 14, 6-9. In this configuration 100, the slave nodes synchronise their clocks to the one master node 5 clock. The master node 5 may or may not be dedicated to providing a timing functionality. The synchronisation between the master node 5 and each slave 1-4 and 6-9, may take place by direct swapping of clock information between respective nodes, as shown by paths A-H. For example, node 1 can synchronise with master node 5 directly as shown by path A. Alternatively, synchronisation may take place indirectly, for example as shown by path I/F, whereby one or more other stations are used as relays to exchange clock information. Following from this, the master node 5 does not need to be physically or logically located in the middle of the slave nodes. The paths from slave to master and master to slave do not need to always follow the same route, during subsequent synchronisations. These paths may change as required. The forward path from slave node to master node can be different from the reverse path, however, in general it is envisaged that the paths will be the same.

FIG. 10b, shows another possible configuration 101 wherein there are a number nodes 1-10 arranged in a hierarchical structure. Each node 1-10 synchronises to the node directly above it in the hierarchy. More particularly, in this structure there is one master node 1. Nodes 2, 5 and 6 synchronise their clocks with this master node 1, and then each of these nodes act as a master to the next level of nodes, eg node 2 is a master for nodes 3 and 4. The nodes in the network may be arranged in any suitable number of hierarchies, as required. For example, node 8 is a fourth level node in the structure that synchronises with the clock of node 7 via path E. Node 7 synchronises with node 6 via path D, which in turn synchronises with node 1 via path B.

FIG. 10c shows a third type of structure 102, in which there is no hierarchy. Rather, the nodes 1-4 are arranged in a fully distributed network. In this arrangement, all the nodes 1-4 synchronise their clocks with logically adjacent nodes. For example, node 1 and node 2 synchronise with each other as indicated by logical path A. This synchronisation process moves the clock of node 1 towards the clock of node 2, and vice versa. Similarly, node 1 synchronises with node 4, node 2 synchronises with node 3, and node 3 synchronises with node 4. This builds redundancy into the system so that the failure of any single part of the system will not cause the complete system timing to fail.

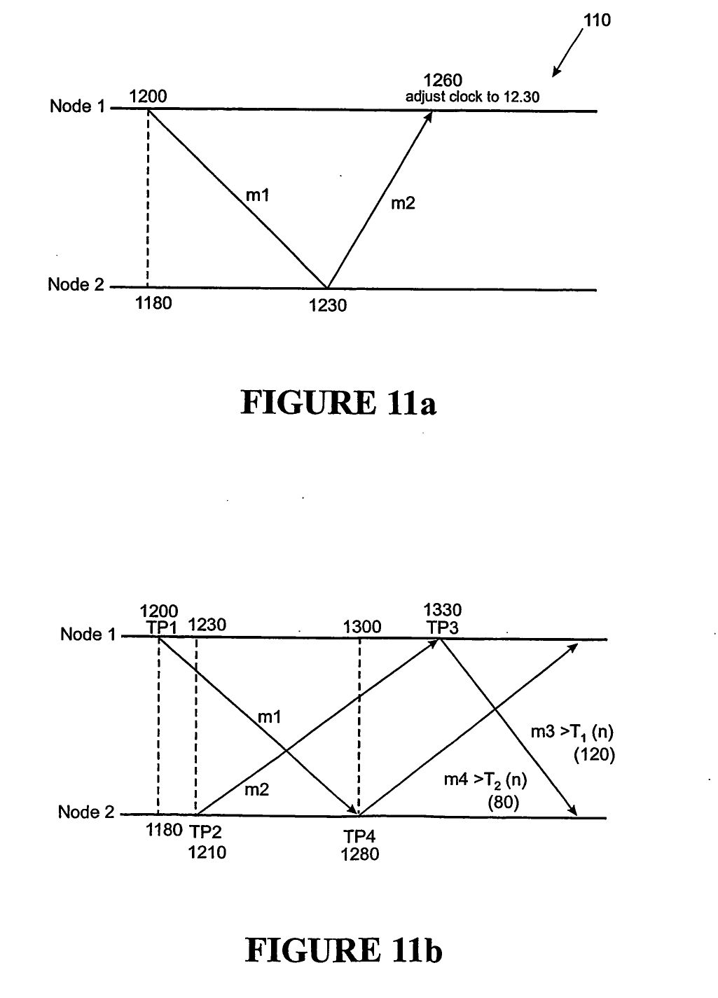

The preferred method of packet exchange between nodes that require synchronisation is shown in FIGS. 11a and 11b, and the general sequence is set out below. This method can be applied, for example, in relation to the three configurations 100, 101, 102 mentioned above, or any other type of node configuration. In a preferred embodiment, synchronisation between two nodes takes place using a three-stage process in which first an initial synchronisation takes place when a new node enters the network, then a coarse synchronisation algorithm is implemented, and finally a fine synchronisation algorithm is implemented. It will be appreciated however, that not all stages are necessarily required for some level of adequate synchronisation to take place, and steps may be left out depending on the application, and required level of synchronisation. Any combination of the stages can be used and omitted as required.

Referring to FIG. 11 a, preferably, an initial coarse clock adjustment 110 is made when a new node 1 enters the network, by sending a request message, M1, from a first node 1 (the new node) to a second node 2 (which, in the case of a single master structure, will be the master node). Upon receiving the request, node 2 sends its current clock reading back to node 1 in a message M2, and upon reception of M2, node 1 adjusts its clock to match clock reading received from node 2. It should be noted that the request from node 1 might not be required. Instead, the second node may send M2 at a certain time that is either be set by a free running timer in the node, or may be triggered by a semi-random occurrence.

An example of this initial synchronisation scheme will be described with reference to FIG. 1 la using an arbitrary set of time values to illustrate the method. At time 1200 according to the clock of node 1, and which corresponds to time 1180 in the clock of node 2, node 1 sends a synchronisation request M1 to node 2 (which can either be predetermined, randomly selected or user initiated). Node 2 receives the request at 1230 according to its internal clock. Node 2 then responds to the request by sending the time at which it receives the request (1230) back to node 1. Node 1 receives the response at time 1260 according to its clock, and then readjusts its clock to read 1230 in accordance with the time reading sent in response from node 2. This synchronises node 1 roughly with node 2.

Preferably, after the initial synchronisation stage has taken place (if required), a coarse synchronisation 6 step clock adjustment is made 111, as shown in FIG. 11b. The horizontal axis displays time increasing from left to right.

In the most basic form the coarse synchronisation has the following steps: at a preset time node 1 sends a message to node 2, when the clock of node 2 reaches the same preset time node 2 sends a message to node 1, each node records the time at which it received the message from the other node, node 1 then subtracts the present time from the time it received the message from node 2 and node 2 subtracts the preset time from the time it received the message from node 1. Either node 1 or node 2 sends this value to the other node. The other node then takes the average of the two values. Either node clock may be adjusted by this average—either by adding or subtracting the average as the case may be to adjust the clock timing.

In another embodiment the method includes the following steps:

1. When node 1 reaches a particular time according to its internal clock, it transmits a timing packet Ml to the node 2. The time at which transmission takes place will preferably be predetermined, although this is not necessary. It could in fact be randomly chosen, user configured, or specified in some other suitable manner. The time at which the message 1 is transmitted with respect to the clock of node 1 is known by node 2. For example, the transmission time could be pre-specified and stored in node 2, or transmitted from node 1 in the contents of the message packet M1.

2. When node 2 reaches a particular time according to its internal clock, it transmits a timing packet M2 to node 1. The time at which transmission takes place will preferably be predetermined, although this is not necessary. It could in fact be randomly chosen, user configured, or specified in some other suitable manner. The time at which M2 is transmitted (with respect to the clock of node 2) is known by node 1. For example, the transmission time could be pre-specified and stored in node 1, or transmitted from node 2 in the contents of the packet M2.

3. When node 1 receives the timing packet M2 of node 2, node 1 calculates a time delay
T1(n)=TP3−TP2

where TP3 is the time at which node 1 (according to its internal clock) receives M2 from node 2, and TP2 is the particular chosen time that node 2 (according to its internal clock) sent the message to node 1. This corresponds to
T1(n)=Tflt+rwt2(n)+Toos(n) [1]
Where Tflt=The flight time for the signal to travel from one node to the other.
Rwt1=The random waiting time of the Ml through the network.
Rwt2=The random waiting time of the M2 through the network.
Toos=The time error between node 1 and node 2.

node 1 then transmits a message M3 to node 2 with the time T1 (n) embedded in its contents.

4. When node 2 receives the first timing packet M1 from node 1, node 2 calculates a time delay
T2(n)=TP4−TP1 [1]
where TP4 is the time at which node 2 (according to its internal clock) receives M1 from node 1, and TP2 is the particular chosen time that node 1 (according to its internal clock) sent the message to node 2. This corresponds to
T2(n)=Tflt+rwt1(n)−Toos(n) [2]
node 2 then transmits a message M4 to node 1 with the time T2 embedded in its contents.

5. At this point node 1 and node 2 have all the necessary information to update their respective clocks timing. The necessary calculations are then completed using the formula:
Toos(n)={T1(n)−T2(n)}/2+error(n) [3]

Wherein the error(n) occurs where transit times for M1 and M2 differ because of differing times of flight (Tflt) and/or random wait times (rwt1, rwt2). Once Toos(n) has been calculated either, node 1 could adjust its timing to minimise the time error between node 1 and node 2, node 2 could adjust its timing to minimise the time error between node 2 and node 1, or both node 1 and node 2 could adjust their timing to minimise the time error between node 2 and node 1. Typically the slave node will adjust its clock by Toos to match the clock of the master. Alternatively, such as when there is no master/slave relationship, each clock may adjust an appropriate amount based on the calculated Toos to make their clocks agree.

Note that both node 1 and node 2 could create redundant messages that will not need to be sent depending on which node is adjusting its clock. For example, if node 2 adjusts its clock to match node 1, it only needs to receive M3. M4 does not need to be sent to node 1 as it is not doing any adjustment. Similarly, if node 1 is to adjust its clock to that of node 2, it only needs to receive M4, and does not need to send M3. If a reciprocal adjustment by both nodes is being carried out, both M3 and M4 require sending.

This process is repeated once every timing period, where a timing period is defined as the time between transmissions of consecutive timing packet exchanges and is chosen as appropriate. A node could adjust its timing by the whole value of the calculated error, or some fraction of this value. More particularly, the timing of a node clock is adjusted by a fraction of Toos(n) such that over an entire timing period it has been corrected by the entire Toos(n). This enables correction to take place continually over the period, rather than in one bigger adjustment at the end of the timing period, by which time the internal clocks may already differ by an unacceptable value. Node 1 and node 2 can transmit their timing packets at the same or different times. The receiving node is made aware of the transmission time according to the transmitting node's clock. M3 and M4 can be sent at any suitable time, no knowledge of the transmit and receive times of these messages is required.

It should be noted that if the calculated time error is too large, it may be assumed that either M1 or M2 is delayed over the network, or there is error in the calculations, and therefore the adjustment could be ignored. In this case the timing would most likely not be adjusted.

It will be appreciated that it is not necessary to calculate T1 and T2 where the transmit times for message 1 and message 2 are the same. By subtracting Ti and T2 to obtain Toos(n) in accordance with equation [3], the initial send time is cancelled out in both cases. Therefore, in such a case the error could be calculated from (TP3-TP4)/2. In this case M3 would only include the time TP3.

An example of this coarse synchronisation scheme will be described with reference to FIG. 11b using an arbitrary set of time values to illustrate the method.

1. When the internal clock of node 1 reaches time TP1=1200 (according to its internal clock) it transmits a first message M1 to node 2. This packet may contain the transmission time, embedded within it, or else node 2 may have been previously been advised of this transmission time. Time TP1 is either predetermined, or specified in some other way as mentioned previously. The time TP1 corresponds to 1180 according to the internal clock of node 2, as the clocks are out by 20 due to various factors as mentioned previously.

2. When node 2 reaches time TP2=1210 (according its internal clock) it transmits a second message packet M2. This packet may contain the transmission time, embedded within it, or else node 1 may have been previously been advised of this transmission time. Time TP2 is either predetermined, or specified in some other way as mentioned previously. The time TP2 corresponds to 1230 according to the internal clock of node 1.

3. Node 1 receives the timing packet M2 at time TP3=1330 (according to its internal clock). It then calculates T1=TP3−TP2=1330−1210=120, wherein TP2 is the transmit time, 1210, according to the internal clock of node 2.

4. When node 2 receives the timing packet M1 from node 1 it calculates the time T2. For example, node 2 receives M1 at 1280 according to the its clock (actually 1300 according to the clock of node 1). Node 1 sent M1 at 1200 according to its clock, therefore T2=TP4−TP1=1280−1200=80.

5. Node 1 then retransmits a message at some later time with the time T1 embedded. For example, node 1, at time TP3, sends a packet message 3 to node 2 including the time difference T1 (120). At this point, node 2 has all the necessary information to update its slot timing. The node 2 determines the error in its clock by the equation (T1-T2)/2, which produces, in this case, (120−80)/2=20−the clock error. It can then adjust its clock accordingly.

Alternatively,

6. Node 2 retransmits a message at some later time with the time T2 embedded.

For example, node 2, at time TP4, sends a packet M4 to node 1 including the time difference T2 (80). At this point, node 1 has all the necessary information to update its slot timing. The node determines the error in its clock by the equation (T1-T2)/2, which produces, in this case, (120−80)/2=20−the clock error. It can then adjust its clock accordingly.

Alternatively both node 1 and node 2 can send messages containing T1 and T2 respectively, and both nodes can then update their clocks to agree. It should be noted that in the above example, there is no time of flight, or random waiting time difference between messages 1 and 2 during transmission.

Preferably, after the initial synchronisation of method 1 and after the coarse synchronisation of method 2 are carried out, a fine synchronisation algorithm that accounts for crystal frequency offsets is executed. This algorithm is intended to compensate for a continual system drift due to the frequency differences in the clock crystals of different nodes in the system and to also average out instantaneous errors in the offset calculations of formula 3. According to the algorithm of Method 2, the average node timing offset is given by:
ToosAvg(n)=K*ToosAvg(n−1)+(1−K)*Toos(n) [4]
Where Toos(n) was calculated using formula 3 and K=a weighting constant where K<1.

K is chosen for a particular application to keep the adjustments stable, but provide a suitable amount of adjustment quickly enough. This process averages out any anomalies, such as missed synchronisation due to packet not being received. By adjusting the timing of the slave node by ToosAvg [4], rather than Toos [3], when using the process shown in FIG. 1, we can compensate for a frequency drift in the system and eliminate most instantaneous errors due to the calculation of Toos [3].

Where it is necessary to compensate for a large degree of clock drift in the system an alternative drift compensation may be required. According to this the expected amount of drift across a timing period (ToosAvg) is computed and the timing of the system is adjusted incrementally by a fraction of this amount at regular intervals. For example timing of the system may be adjusted n times per timing period according to the relationship:
ToosFraction=ToosAvg/n [5]

Where n is some integer.

If the calculated value of Toos (equation 3) is too large in comparison to the expected drift error, it may be assumed that one of the messages was delayed over the network or there was an error in the calculations. Therefore the calculated Toos value will be ignored. In this case the ToosAvg will not be changed and timing will be adjusted by ToosAvg (or ToosFraction), therefore accounting for system drift without introducing any new errors.

It will be appreciated that the timing protocol implementation can be used in any type of network that requires synchronisation. The invention is not restricted to implementation only in the radio communications system, and more particularly the Ethernet setup described here.

4. Dynamic Bandwidth Allocation

A preferred embodiment of the radio system 100 may further implement dynamic bandwidth allocation for data transmissions to increase and decrease the user bandwidth on demand. The transmission scheme shown in FIG. 3 illustrates an example of a communication link. A communication link enables transmission of data at a set bit rate, for example 18 kbit/s. In a preferred embodiment of the channel allocation invention, as capacity becomes available, the system 100 can be adapted to open additional transmission links between a transmitting terminal, eg MT1 101 and a receiving terminal, eg MT2 102. The data for transmission can then be split into multiple streams, all sent down a separate link, and recombined at the receiving terminal.

In an example provided for explanatory purposes, a terminal T1 initialises a call to T2. T1 has the option of specifying the bandwidth of the call in 18 kbit increments. Firstly, T1 sends a ‘call setup’ request to T2 and specifies the number (N1) of 18 kbit links requested by T1. This call setup request contains all routing information of all N1 individual links. T2 then replies with up to N1 ‘call setup acknowledgments’ to each N1 channel individually. T2 does not need to reply to all N1 links. For example, if T2 only has N2 number of channels free at its location it will only reply to N2 links. Preferably, when T1 and T2 negotiate the number of channels to use, there would be some free channels remaining. After receiving T2's reply, T1 would proceed to use the links that had been successfully acknowledged, by splitting the data stream into N2 streams. On receiving the separate streams, T2 would recombine the original data.

In the event of there being a demand for a higher data rate, one of the terminals, T1 or T2, firstly determines whether there is spare capacity at the local end. If so, it sends the link routing information to the other end via one of the existing links. The destination end will then perform a similar analysis of its own wireless link and will determine whether there is enough capacity for an extra link. If so, the new link is established by sending an acknowledgment using this free link.

In the event of the spare capacity in the local area reducing, ie of the terminal moving into a busier area or of a third terminal moving in, the affected terminal simply stops using one of the links. This would stop air traffic on that link immediately and the link would immediately be seen to be free by other terminals. The terminal on the other end would rely on a time-out mechanism to clear its internal table.

One possible implementation for the recombining of the data-stream could utilise a sequence number in each of the packets. When the number of links changes from say 4 to 3, an example of the received packets during the transition could be
2,3,1,4|5,7,6,8|9,11,12,10|13,15,14,X|17,18,16,X| . . .
   where the number shows the sequence number tag in each packet. For the first three multi-frames, there are four packets received, while for the last two, the transmitter only has three links per multi-frame and the X indicates the slot no longer in use and is waiting to timeout. A suitable reordering algorithm can be implemented to reorder the data stream without glitches during the change over.

In communication between mobile terminals MT1 and MT2 the mobile terminals determine whether spare uplink or downlink channels are available. The mobile terminals may use terminal base registers to determine the availability of spare channels. If for example, MT1 determines that a spare uplink channel is available it transmits this information to MT2 using a channel already in use between the two mobile terminals. MT1 then begins to use the additional channel in communication with MT2. If either MT1 or MT2 becomes aware that a channel currently in use is subject to severe interference the mobile terminal may stop using that channel and search for a new channel. Channels with severe interference can be identified during the macrodiversity process. All channels identified would be within range of a base station.

If MT1 identifies a channel that may be used by MT2, MT1 instructs MT2 to begin using the additional channel. This channel allocation can be used without negotiation with any of the base stations involved. Alternatively the mobile terminal may identify a spare downlink channel and instruct a base station to use the spare downlink channel.

It will be appreciated that the channel allocation invention can be implemented, in general, in any type of radio communications system that would benefit from an increased number of downlink channels for data. The channel allocation invention is not restricted to implementation only in the radio communications system described here.

5. Frequency Hopping

Where required, because of regulatory constraints and/or security issues, frequency hopping on the uplink and/or downlink, may be implemented in the preferred embodiment of the invention. Frequency hopping spreads the transmit power over a band of frequencies, by altering the carrier frequency at regular intervals. The receiver then adjusts the receive circuitry accordingly to tune into the varying carrier frequency. In this manner, the transmit power is not concentrated on just one carrier frequency. Further, by having a predetermined frequency hopping regime that is known only to the transmitting and receiving apparatus, third party hackers cannot eavesdrop on the channel, as they do not know which carrier frequencies to switch to.

In the preferred communications system 100 described, a preferred embodiment of a frequency hopping invention is invoked in which the carrier frequency change is triggered at each new time slot. In this manner, frequency hopping takes place 32 times for each TDMA frame. Circuitry can be provided to carry out this function, or alternatively it can be implemented in existing circuitry, such as in a microprocessor.

It will be appreciated that the frequency hopping invention can be implemented, in general, in any type of communications system or equipment that would benefit from such a scheme. The frequency hopping invention is not restricted to implementation only in the radio communications system described here.

6. Data-Shaping to Minimise False-Synchronisation Events

A data stream transmitted in the system 100, includes synchronisation sequences embedded within the bitstream to assist in synchronising the transmit and receive equipment involved in the communication. These synchronisation sequences contain a predetermined sequence of symbols for which the receiver synchronisation circuit searches. The receiver synchronisation circuit is activated at certain times in a preferred embodiment of the invention, to match a window around the expected occurrence of the synchronisation sequence. Alternatively, the search window for synchronisation data is widened progressively as the time since the last successful synchronisation detection increases. This is in order to cater for a mismatch in the clocking rates of transmitter and receiver. In many cases the search window in the receiver synchronisation circuit may overlap portions of the bitstream in which payload is transmitted. If a portion of the payload were in some circumstances to resemble a synchronisation sequence, then this would be mistakenly interpreted by the receiver synchronisation circuit as a synchronisation event, thus disturbing the synchronisation process.

In a preferred embodiment of the invention, the receiver synchronisation circuit attempts to match a portion of the binary digits in the data bitstream against the predetermined synchronisation pattern, and will measure the difference, or error, between the two. This may be done by any suitable method, for example by inspecting Hamming distance between the two. The Hamming distance is a count of the number of bits in the incoming stream that differ from the predetermined synchronisation. Alternatively another measure, such as an analogue Euclidean distance, could be used. If the similarity between the bitstream entering the receiver synchronisation circuit and the predetermined synchronisation pattern is greater than an adjustable, or adaptive threshold, then the receiver judges that a synchronisation event has occurred.

In a preferred embodiment, the transmitters in the communications system, as a guard against false synchronisation, may examine the transmitted bitstream for similarity to the predetermined synchronisation pattern, preferably but not necessarily using identical criteria to the receiver. Where an unwanted match would occur, the transmit bitstream is deliberately altered in order to decrease its similarity to the predetermined synchronisation pattern. This deliberate alteration utilises an error correction technique already implemented in the system, for example a Hamming code. The introduced alteration makes the payload bit stream sufficiently different from the synchronisation word to avoid detection as that word, and the error correction method subsequently, upon reception of the altered bit stream, alters it back to its correct form, after the synchronisation detection circuitry has inspected the bit stream. Since noise is likely to be present within the communications system, the invention may be considered to reduce or otherwise shape the noise immunity of the communications process in order to avoid false synchronisation events.

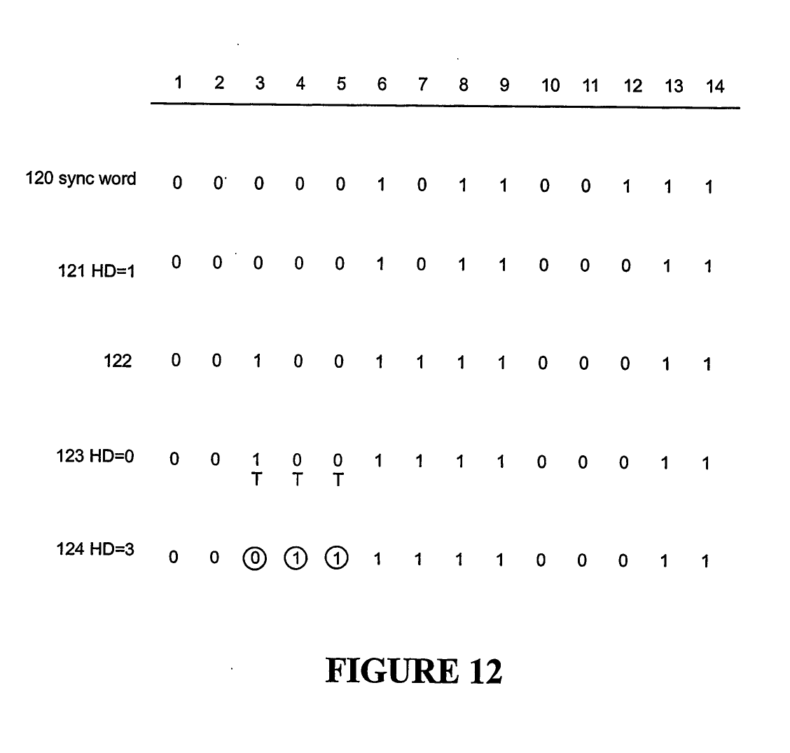

Referring to FIG. 12, the present invention includes a predetermined synchronisation word, eg 120, in the transmitted data stream that may be either set in the system firmware, or under software control, as required. It is 16 bits in length, of which 14 bits are significant. Receiver circuitry allows the receiver to clock in the received data stream bit-by-bit, examining a moving window of 14 bits for detecting the synchronisation word. Every time a bit is clocked in, it and the previous bits, are compared to the 14 significant bits of the stored synchronisation word.

A software configurable detector checks that either 12, 13 or 14 (depending upon user configuration) of the incoming stream bits match the predetermined synchronisation word 120. If the bits match to the required Hamming distance, then a synchronisation event occurs. For example, a 13 out of 14-bit match may be sought. This corresponds to the detector triggering on a Hamming distance of 0 or 1. For example, as shown in FIG. 12, bit stream 121 includes 14 bits that differ from the synchronisation word by only 1 bit (bit 12). Therefore, 13 of the 14 bits match the synchronisation word 120. This corresponds to a Hamming distance (HD) of 1. The detector therefore triggers on bit stream 121 as a synchronisation word. However, referring to 122, 2 bits are different (3, 7) which corresponds to a Hamming distance of 2. In the situation where 13 out of 14 bits have to match the synchronisation word, this 14-bit window 122 of a bitstream would not be detected as a synchronisation word.

Sometimes received packets are slightly delayed. For example, a packet received from a distant transmitter will arrive later than that from a nearby one. If the terminal has been ‘talking’ to a nearby base station, it will synchronise to that. The terminal therefore expects the synchronisation bitstream embedded within the received packet to arrive at a particular time. If the terminal picks up a transmission from a distant base station, a detection window will be opened at the normal time, and find the distant base station is still transmitting certain payload bits that are sent before the synchronisation word. If those payload bits resemble the synchronisation word, the receiver may detect them as such, resulting in a mis-synchronisation problem.

For example, the actual synchronisation word 120 could be 0×0167 in hexadecimal, which starts with 7 consecutive zero bits (only 5 are shown in FIG. 12), and ends with three consecutive ones. The maximum delay on a packet means that a delayed sync word will always overlap with the expected location of a real one. To overcome the problem, every transmitted packet from every base station is inspected just before transmission in the section of the data sequence just preceding the synchronisation word. This data sequence is scanned to detect the synchronisation word pattern and every other possible variant within a Hamming distance of 0, 1 or 2 depending on the detection scheme that has been configured.

A Hamming distance of 0 corresponds to a detection scheme that has been configured to seek a 14 out of 14 match. Similarly, Hamming distances of 1 and 2 correspond to matches of 13 out of 14 bits, and 12 out of 14 bits respectively. If a match of a sequence in the payload bitstream (ie a particular word within the Hamming distance required by the receiver) with the synchronisation word is found, the transmit circuitry toggles bits accordingly. In the case that the transmitter is configured for a 12 out of 14 match and an erroneous exact match is found eg 123, the transmitter circuitry toggles 3 its (eg 3, 4, 5) in the payload sequence to make a new bitstream 124 with a Hamming distance equal to 3. Alternatively, if a Hamming distance of 1 is detected, the transmit circuitry toggles 2 bits in the payload sequence to make the total Hamming distance equal to 3. Alternatively, if a Hamming distance of 2 is detected then the transmit circuitry toggles 1 bit to make the Hamming distance equal to 3.

Similarly, if the circuitry is configured for a 13 out of 14 match and an erroneous exact match is found, the transmit circuitry toggles 2 bits in the payload sequence to make the Hamming distance equal to 2. Alternatively, on detection of a Hamming distance of 1, the transmit circuitry toggles 1 bit to make the Hamming distance equal to 2. Where the circuitry is configured for a 14 out of 14 match, and an erroneous exact match is detected, 1 bit in the payload sequence is toggled to make the Hamming distance equal to 1.

In this embodiment, the error correction scheme used is RS(48,32,8) Reed Solomon or higher over GF(8) on packet data. The data-shaping scheme can utilise the error correction scheme already being used by the transmission system. Using this, approximately 16% of errors per block can be corrected. The location of 3 bit errors is important to the error correction algorithm since it is byte based. It is easier for a Reed Solomon system to correct a totally incorrect single byte than it is to correct a single toggled bit in each of 3 successive bytes. When choosing bits to toggle it is important not to unintentionally introduce another match with the synchronisation word at a slightly different bit position, or unintentionally toggling non-matching bits, such as the 2 bits that are not matching in a 12 out of 14 match.

In a preferred embodiment of the invention, bits as far as possible to the right hand (later) end of the matching portion of the bitstream are chosen. Preferably, the last byte of the matching portion is set to OxFF hexadecimal (all high), since this pattern does not occur in the synchronisation word. In general, it has been found preferable to set the byte to a value that has maximal Hamming distance from all bit-shifted portions of the synchronisation word. Once the appropriate pre-transmission alterations are made, the datastream is transmitted, received, and then corrected in accordance with the error correction code being used by the system, in this case a Hamming code.

The preferred embodiment describes the use of a predetermined synchronisation pattern, whereas a person skilled in the art would appreciate that under certain circumstances the synchronisation pattern could, or would be altered. This may include switching synchronisation patterns themselves to avoid similarity to the transmitted data. In the preferred embodiment, the data within the transmitted bitstream that is adjusted upon transmission may be bits within the datastream, either placed there for the express purpose of decreasing similarity, or may be existing unused bits. Furthermore, the transmitted bitstream is coded using an error-correcting code, and is thus tolerant to a certain number of bit adjustments. It is preferable that the error-correcting code tolerance is related to the dissimilarity tolerance of the receiver synchronisation circuit. Thus if the demands of the receiver synchronisation circuit require that 2 bits within the bitstream must be adjusted to avoid false synchronisation, the error correcting code will at least be capable of correcting those 2 bits within the receiver apparatus. Any suitable error correcting code may be used, and as mentioned, preferably the existing code used by the system is utilised.

In the communication system of the present invention mobile transceivers 101-105 will perform the data shaping before transmitting data to another mobile transceiver via one or more base stations.

A person skilled in the art would readily understand that binary digits may be extended to communication symbols of other more generic forms, whilst the data bitstream may be considered a symbol stream. This includes analogue as well as digital systems. An alternative embodiment would be the application of the circuit to a symbol stream consisting of multi-bit symbols, frequencies or code words. Similarly, the Hamming distance is one measure of similarity whereas a multitude of other measures known in the art may be applied within the invention.

It will be appreciated that the synchronisation packet distinction invention can be implemented, in general, in any type of radio communications system that would benefit from such a method. The invention is not restricted to implementation only in the radio communications system described here.

7. Distribution of Terminal Base Register (BR) Among All Terminals on the Network

In accordance with a preferred embodiment of the invention, the system 100 implements TBRs, eg 120, 121 as shown in FIG. 1. These contain information on which base stations 110-116 and time slots are allocated to which mobile terminals 101-105, for both uplink and downlink traffic. The base station and time slot allocations are chosen by the terminals 101-105, in accordance with the scheme described in the terminal handover protocol section. In a possible embodiment, one TBR may store all the information. However, in a preferred embodiment, a plurality of TBRs are utilised. Each TBR may contain all the information for all mobile terminals, or alternatively, the information may be distributed among the TBRs on the system. The multiple TBRs provide redundancy to improve system reliability. The TBRs may be implemented in terminals the same as or similar to the mobile terminals, and may either be mobile or fixed in position. In one possible embodiment, one or more of the mobile terminals 101-105 also function as TBRs, avoiding the need for dedicated TBR terminals.

Each mobile terminal 101-105 on the system 100 has the locations (ie srcPBS, dstPBS, dstSBSl, and dstSBS2) for all TBRs 120, 121 programmed into its memory, along with the associated TBR 120, 121 transmission time slots. If a particular TBR detects that any of its PBSs or SBSs have changed, then it will send a broadcast message to all terminals 101-105 on the system, to alert them of the fact. The terminals 101-105 will then update their memories with the new information. On making a call, a transmitting terminal, eg MT1 101, requires information identifying its srcPBS and timeslot, along with the dstPBS, dstSBS1 and dstSBS2 of the receiving terminal, eg MT2 102. MT1 101 will do this by contacting a TBR, eg TBR 120, using the TBR location information stored in its memory. The TBR 120 will then provide the MT2 102 location (ie dstPBS, dstSBS1, and dstSBS2) information to the terminal MTI 101.

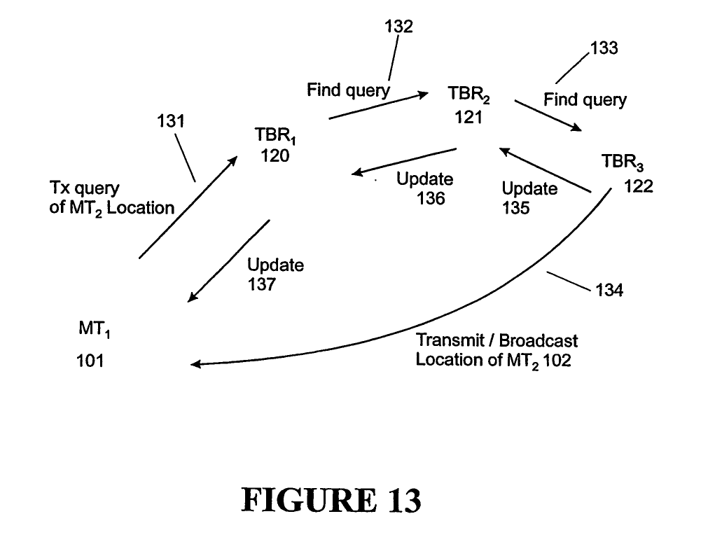

In larger systems, where more than one TBR may be required for efficient storage of preferred base stations for each terminal if the TBR 120 does not hold the information, it will forward the request onto another TBR, eg TBR 121. FIG. 13 depicts such a scheme. MT1 101 queries the location of MT2, that is, it queries what base stations MT2 102 uses on the downlink. The request is trsmitted 131 to TBR1 120, which checks if it contains the information. If it does not, the query is forwarded by retransmission 132 to TBR2 121 which in turn checks whether the information in its table. Still further retransmissions 133, eg to a TBR3, may take place until the information is found. The TBR (eg TBR3) that has the information then transmits or broadcasts 134 it back to the requesting terminal MT1 101. The TBRs (eg TBR1 120, TBR2 121) that do not contain the information can request the information be sent back also to them 135-137, so their internal tables can be updated with the information to provide redundancy. Once the base station and timeslot information has been found at one of the TBRs, it is returned to MT1 101 so that the call can be made and traffic directed to the destination terminal MT2 102.

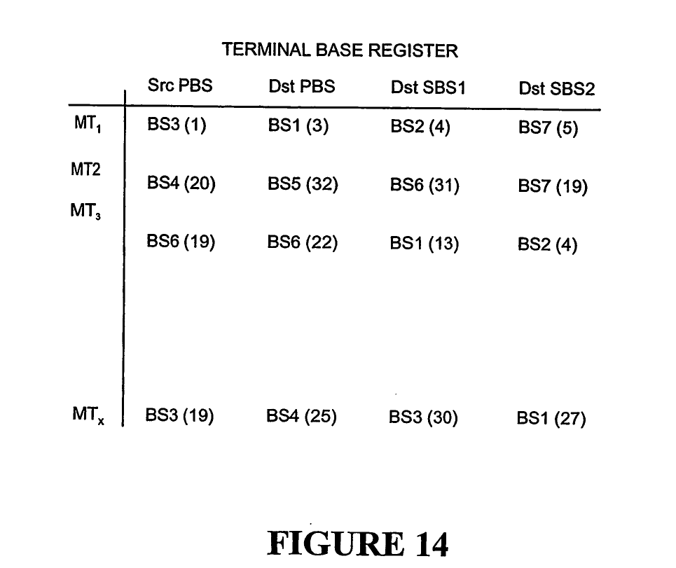

FIG. 14 shows one preferred storage scheme, in a TBR, of base station and timeslot allocations. The table specifies, for each mobile terminal MT1-MTx 101-105, the selected srcPBS, dstPBS, dstSBS1, dstSBS2 and corresponding time slots, in brackets. Each time slot number refers to one of the 32 available transmission slots 603 in a TDMA frame 604.

In a further embodiment, the terminal base register structure enable multiple fleets to use the system 100 independently from each other. The TBRs ensure that traffic origination from one fleet using the system 100, can only be received by others in that fleet, and is not accessible by additional fleets. The TBRs can implement terminal authentication to provide security in any such system.

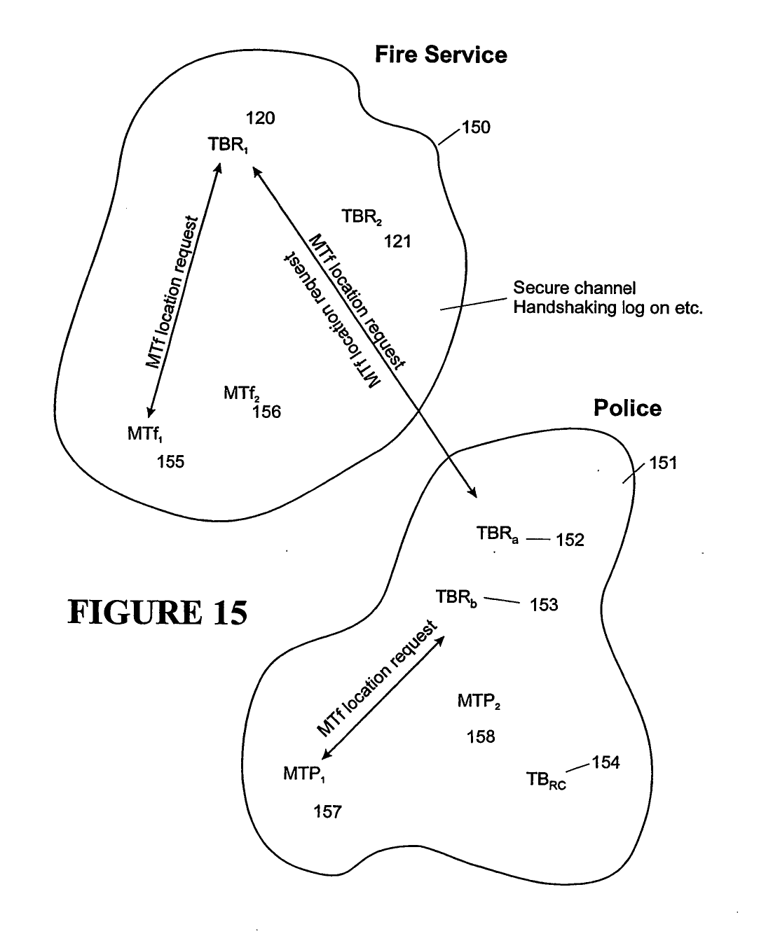

FIG. 15 shows schematically how such a system is arranged. Fleet 1 150, eg the fire service, share the same base station network 100 as fleet 2 151, eg the police. It will be appreciated that the boundaries shown in FIG. 15 do not represent physical communication boundaries, but rather diagrammatically indicate the independent communication schemes for each fleet. The terminals, eg MTF1 155, MTF2 156, MTP1 157, MTP2 158, used by each fleet 150, 151 are free to roam and share use of base stations in the system 100. TBR1 120 and TBR 2 121 contain terminal location (ie selected uplink, downlink base stations) for fleet 1 150, which TBRa, TBRb, TBRc 152-154 contain terminal location information for fleet 2 151. Any call from a terminal in fleet 1, eg MTF1 155 uses TBR1, or TBR2 to establish the location of the other terminal, eg MTF2, with which it will communicate. Similarly, TBRa 152, TBRb 153 and TBRc 154 perform the same function for fleet 2 communication. Where traffic is to take place between a terminal of fleet 1, eg MTF1 155 , and a terminal of fleet 2, eg MTP1 157, then one of the TBRs, eg TBR1 120 for fleet 1 establishes communication with one of the TBRs of fleet 2, eg TBRa 152, to obtain terminal location information to enable the transmissions to proceed.

It will be appreciated that the TBR implementation can be used to store network configuration information in any type of radio communications system. The invention is not restricted to implementation only in the radio communications system described here.

8. Collective Intelligence

Several overall features of the invention emerge as a result of the interaction between the components and protocols used. This provides the system with a “collective intelligence”. As mentioned previously, base station and channel allocation and use is controlled by the terminals 101-105 rather than the base station, which is typical in existing communication systems. The terminals can be programmed to arrange communication in accordance with predetermined rules, which can be changed as required. This terminal focus provides a self-organising cell structure which is more adaptable to reconfiguration, introduction or removal of system resources, changing use requirements, introduction of new user services and functions, and the like. In existing systems, the base station network is preconfigured based on the nature and number of the stations, the environment they are working in, and the end use. This makes it difficult to adapt the system, as reconfiguration of the base stations, and perhaps an overriding system control centre can be required. For example, base stations can be added and removed in the present invention on an ad hoc basis, as the nature of terminal control allows adaptation to changes in system resources.

Further, the system more readily adapts to interference, equipment failure, geographic disadvantages and the like, as the terminals choose base stations and channels based on perceived quality, rather than geographical location, like in existing cellular systems. The terminal control also leads to a continuous “soft” handover between stations, rather than “hard” geographical handovers. This enables the system to adapt to deadspots and the like, which may occur, by utilising system resources in another geographical location that may provide better channel quality. This quality is assessed at each receiver in the path and this assessment is forwarded to each terminal to allow it to make the best decision of which path or resource to use. This is particularly suitable for indoor applications, or small campuses, where buildings will have a large influence of channel quality on a small scale.

The flexible nature of the channel allocation control also enables overlap of channels in adjacent cells. Further, unlike in traditional cell systems where channels must be reserved for roaming terminals that may enter the cell, the present system can reduce the number of channels that require reservation, as the terminals are adapted to change channels where conflicts arise. On this note, it will be appreciated that while the preferred embodiment of the invention utilises TDMA, the principles of the invention could be applied to any other suitable transmission scheme, such as CDMA, FDMA and the like.

The terminal driven system also enables new services to be introduced relatively simply, by way of updating the terminals. The base stations act mainly as “relays” and therefore do not need reconfiguration for the system to provide new features. The base station network does not need to know the type of traffic it carries or its purpose. The terminals provide the base stations with the information they need to transmit messages across the system, for example, by embedding channel/base station allocations in the transmitted message.

9. Distributed Transmission Parameter Adjustments

In a preferred embodiment, terminals monitor the communications environment around them and constantly determine suitable transmission parameters, such as time slots, frequencies or base stations based on in-built communications quality criteria. If, at any time during an ongoing call, quality reduces to unacceptable levels, new transmission parameters are chosen dynamically from a pool of available resource. In our system, this resource includes channels and base stations but could readily encompass frequencies, orthogonal symbols, power or other adjustable transmission parameters.

In addition, a terminal is responsible for maintaining records of a good set of channels and base stations in the TBR, to allow other terminals to contact it. If those resources set in the TBR become blocked, or appear to have insufficient quality, then the terminal will choose a new set of good resources and update the TBR accordingly. The mobile terminal therefore is responsible for tracking various items: channels and base stations involved in any current call, and channels and base stations previously supplied to the TBR.

Channels are therefore chosen dynamically by a mobile terminal to suit the conditions currently around it, rather than as specified by a base station. This behaviour of the mobile terminal is related to the property of the network in the preferred embodiments of the invention that we refer to as collective intelligence, and is in contrast to existing systems where the base stations would control channel allocation.

The base station and channel selection process undertaken by each terminal will be described with reference to FIG. 1. Each terminal 101-105 in the system continually monitors traffic on the system to make decisions as to which base stations and channels it will utilise for downlink reception, that is downlink traffic which it receives via one or more base stations 110-116. Also, by assessing traffic on the system, each terminal selects a channel for uplink broadcast, that is for uplink traffic to one or more base stations 110-116 within range of detectability. Each terminal also assesses the traffic to select a source base station. Uplink broadcasts from a terminal that is received by one or more base stations 110-116 are forwarded to the selected source base station for diversity combining, and then forwarded to the dstPBS of the receiving terminal.

To make this assessment a terminal, eg MT1 101, monitors all traffic from all base stations that it can detect. The assessments are made at suitable regular intervals, for example every 1/8 seconds, and are carried out irrespective of whether the terminal MT1 101 is engaged in communication with another terminal, eg MT2 102, or not. The terminal MT1 101 assesses both the effectiveness of each detectable base station transmission 110-116, and additionally the density of traffic on each channel. The terminal then selects the base station 110-116 that displays the best downlink quality as its primary destination base station dstPBS, for relay of incoming traffic. The base station with next best quality is selected as a secondary destination base station dstSBS1, and a further secondary base station, dstSBS2, is then chosen in like manner. Similarly, the traffic is assessed and the terminal MT1 101 selects a source base station, srcPBS, which performs diversity combining.

For example, as shown in FIG. 3, which depicts a transmission from MT1 101 to MT2 102, MT2 has selected BS5 114 as its dstPBS, and BS7, BS6 116,115 as its first and second secondary destination base stations through which it will receive downlink traffic from MT1 101. MT1 has selected BS3 112 as its srcPBS. The reverse channel (from MT2 102 to MT1 101) is not shown, however similarly, MT1 101 will have selected downlink base stations, and likewise, MT2 102 will have selected a primary source base station, for diversity combining of uplink traffic.

A person skilled in the art would understand that this process could be used for any number of secondary destination base stations, although this particular embodiment utilises two secondary base stations. When fewer base stations are detectable than are required, the system will duplicate secondary base station allocations rather than drop the call. If necessary, even the primary base station may be a duplicate of the secondary base stations, although this is not desirable, and will be corrected when another base station becomes detectable.

The terminal MT1 101 also selects both an uplink channel and a number of downlink channels for use by the selected source and destination base stations respectively. In the particular embodiment described, three downlink channels are selected to provide time diversity, and are allocated to the dstPBS 114, dstSBS1 116 and dstSBS2 115 base stations respectively. Each base station transmits a list of free uplink and downlink channels in its instruction slots. The terminal stores this information and uses it to select a free uplink channel, on which it broadcasts messages, and three downlink channels for use by dstPBS 114, dstSBSl 116 and dstSBS2 115 base stations respectively for downlink traffic received from another terminal, eg M12 102. The remote terminal with which the terminal communicates, and each base-station in the intervening link, generates quality information that the remote terminal sends back, as part of its instruction slots, to the calling terminal during an ongoing call. The calling terminal uses this information to assess whether the free uplink channel selected is, in fact, of sufficient quality.

These links are regularly reassessed (for example, 8 times a second in the particular embodiment described) for quality. The selected base stations may be changed regularly, for example every multi-frame, due to the terminal moving or changing environmental conditions. The decisions are not determined by the geographical placement of base stations, as is done in traditional radio cellular networks. Rather, decisions are made on signal quality, and other suitable transmission parameters. Therefore, a terminal can select several base stations that may not be adjacent, or even close, geographically.

FIGS. 4a and 4b provide an example of base station 106-110 selection as a terminal MT1 101 travels from a first point to a second point through the base station system 100. During portion A of its journey, MT1 101 selects BS11 10 as its srcPBS and BS1 110, BS2 111 and BS3 113 as its dstPBS, dstSBS1 and dstSBS2 respectively. As MT1 101 moves into portion B of its travel, it reselects the stations BS2 111, BS4 113, BS2 111 and BS3 112 respectively. In portion C of its travel, it reselects the stations BS4 113, BS3 112, BS4 113 and BS5 114. As is apparent from this, the closest base stations are not always chosen by MTI 101. That is because the best reception may come from base stations further away, due to nearer base stations being obscured, due to, for example buildings or the like.

Terminals preferably will select base stations which they have recently seen carrying most good traffic, or free but of high signal quality. As channels are selected similarly this is not a simple space diversity system—it combines time diversity and base station/channel reuse with overlapping cells of undefined shape whereby each terminal adapts optimally to its local conditions.

Preferably the selection of multiple data downlink channels will be consecutively grouped, with the associated uplink channels being spaced, if possible. An alternative embodiment might alter this arrangement to ensure both an efficient link and to enable a terminal to detect other traffic around it. The chosen base stations and channels are stored in one or more of the TBRs 120, 121 in a manner that will be described later. It is the responsibility of each terminal to update the TBR with an adequate set of channel information, and continually reassess this information, updating when necessary. The total number of hand-overs can often be reduced using this scheme, as a terminal may keep the same channel when it moves from one base station to another.

Where a base station 110-116 has no traffic, it will periodically transmit beacon data to enable terminals 101-105 to assess signal quality. A beacon is transmitted when an entire transmission frame, compiled in advance, contains no traffic. A beacon is then inserted into the frame structure on a random channel in the preferred implementation. A person skilled in the art would understand that a fixed channel, or one dynamically chosen according to some criteria such as to minimise traffic or interference, could be used in an alternative implementation.

The foregoing describes the invention including preferred forms thereof. Alterations and modifications as will be obvious to those skilled in the art are intended to be incorporated in the scope hereof as defined by the accompanying claims.

1-119. (canceled)

120. A communications system including:
a plurality of base station transceivers linked by a network over which the base station transceivers communicate;
a plurality of mobile transceivers adapted to communicate via the base station transceivers using macrodiversity; wherein
the mobile transceivers are further adapted to control allocation of system resources to enable communication.

121. A communications system as claimed in claim 120 wherein the macrodiversity includes macrodiversity at a base station transceiver when receiving a signal from a mobile transceiver.

122. A communications system as claimed in claim 120 wherein the macrodiversity includes macrodiversity at a mobile transceiver when receiving a signal from a base station transceiver.

123. A communications system as claimed in claim 120 wherein the channel resources allocation controlled by the mobile transceiver includes the use of base station transceiver channels in a communications downlink between a base station transceiver and a mobile transceiver.

124. A communications system as claimed in claim 120 wherein the channel resources allocation controlled by the mobile transceiver includes the use of base station transceivers in a communications downlink between base transceivers and a mobile transceiver.

125. A communications system as claimed in claim 120 wherein the channel resources allocation controlled by the mobile transceiver includes the use of base station transceiver channels in a communications uplink between a base station transceiver and a mobile transceiver.

126. A communications system as claimed in claim 120 wherein the channel resources allocation controlled by the mobile transceiver includes the use of base station transceivers in a communications uplink between base transceivers and a mobile transceiver.

127. A communications system as claimed in claim 120 wherein the base station transceiver network is shared with other services.

128. A communications system as claimed in claim 120 wherein the base station transceiver network includes a link to another base station transceiver network.

129. A communication system as claimed in claim 121 wherein the mobile transceiver is adapted to use macrodiversity by sending a packet to a plurality of base station transceivers.

130. A communications system as claimed in claim 129 wherein a base station transceiver or other network node is adapted to use macrodiversity when receiving a signal from a mobile transceiver by receiving packets from a plurality of base station transceivers that have received packets from the mobile transceiver, and combining the received packets using diversity combining.

131. A communication system as claimed in claim 130 wherein the base station or other new work node is further adapted to use macrodiversity when receiving a signal from a mobile transceiver by forwarding the combined packet to at least one specified base station transceiver for transmission to another mobile transceiver.

132. A communication system as claimed in claim 122 wherein the base station transceivers are adapted to use macrodiversity by sending a packet from a plurality of base station transceivers to a mobile transceiver.

133. A communications system as claimed in claim 132 wherein a mobile transceiver is adapted to use macrodiversity when receiving a signal from a base station transceiver by receiving packets from a plurality of base station transceivers and diversity combining the packets.

134. A communication system as claimed in claim 120 wherein mobile transceivers are adapted to allocate system resources by:
identifying uplink channel usage in the range of the mobile terminal, identifying one or more spare uplink channels, and transmitting over the one or identified channels without negotiation with the base station.

135. A communication system as claimed in claim 134 wherein the mobile transceivers are further adapted to allocate system resources by identifying a spare uplink channel for transmission to minimise interference.

136. A communication system as claimed in claim 120 wherein mobile transceivers are adapted to allocate system resources by:
identifying downlink channel usage in the range of the mobile terminal, identifying one or more spare downlink channels, and instructing a transmitting mobile terminal to utilise the identified channel(s) for transmission.

137. A communication system as claimed in claim 136 wherein the mobile transceivers are further adapted to allocate system resources by identifying a spare downlink channel for transmission to minimise interference.

138. A communication system as claimed in claim 134 wherein a transmitting mobile transceiver is adapted to negotiate the number of links with a receiving mobile transceiver.

139. A communication system as claimed in claim 134 wherein the mobile transceivers are adapted to split the data to be transmitted into multiple streams and transmit each stream over a separate link.

140. A communication system as claimed in claim 139 wherein a mobile transceiver receiving data transmitted over multiple streams is adapted to combine the multiple data streams.

141. A communication system as claimed in claim 134 wherein the mobile transceivers are adapted to stop using a link if the amount of available channel resources reduces.

142. A communication system as claimed in claim 120 wherein the mobile transceivers are adapted to transmit a data stream from a first mobile terminal to a second mobile terminal over a communication system by:
identifying one or more spare channels for the downlink to the second terminal,
separating the data stream into multiple portions according to the number of identified spare channels, and
transmitting the multiple portions over the spare channels to the second terminal.

143. A communication system as claimed in claim 120 wherein before transmitting data packets, each packet including a synchronisation sequence and a payload sequence, a mobile transceiver is adapted to provide a distinction between payload sequences and synchronisation sequences in the signal to be transmitted by scanning the payload sequence to determine any portions of the sequence that could be detected as a synchronisation sequence, introducing errors into the portions of the payload sequence, and wherein the introduced errors are within an error correction capability of a payload error correction code.

144. A communications system as claimed in claim 120 further including at least one register that can communicate over the communication system and adapted to store at least a portion of the base station transceiver and time slot allocations of the mobile transceivers.

145. A communication system as claimed in claim 144 wherein each register stores at least a portion of the base station transceiver and time slot allocations of each mobile transceiver.

146. A communication system as claimed in claim 144 wherein a mobile transceiver uses a register to find the primary and secondary destination base station transceivers or a destination mobile transceiver.

147. A communication system as claimed in claim 120 wherein the mobile transceivers use signal quality metrics to determine a link over which to transmit.

148. A method of communicating over communication system including a plurality of mobile transceivers and a plurality of base station transceivers where the base station transceivers are linked together by a network including the steps of:
transmitting a signal in the form of packets from a transmitting mobile transceiver, each packet including information identifying a receiving mobile transceiver and at least one destination base station transceiver,
receiving the packet(s) at at least one receiving base station transceiver,
forwarding the packet(s) to the at least one destination base station transceiver, the destination base station transceiver transmitting the packet(s) to the receiving mobile transceiver, and wherein
at least one of the receiving base station transceiver and the receiving mobile transceiver uses macrodiversity, and wherein
the mobile transceivers control allocation of system resources.

149. A method of communicating over a communication system as claimed in claim 148 wherein the channel resources allocation controlled by the mobile transceiver includes the use of base station transceiver channels in a communications downlink between a base station transceiver and a mobile transceiver.

150. A method of communicating over a communication system as claimed in claim 148 wherein the channel resources allocation controlled by the mobile transceiver includes the use of base station transceivers in a communications downlink between base transceivers and a mobile transceiver.

151. A method of communicating over a communication system as claimed in claim 148 further including the step of the mobile transceiver using macrodiversity by sending a packet to a plurality of base station transceivers.

152. A method of communicating over a communication system as claimed in claim 151 wherein a base station transceiver or other network node uses macrodiversity when receiving a signal from a mobile transceiver including the steps of receiving packets from a plurality of base station transceivers that have received packets from the mobile transceiver, and combining the received packets using diversity combining.

153. A method of communicating over a communication system as claimed in claim 152 wherein the base station or other new work node uses macrodiversity when receiving a signal from a mobile transceiver including the step of forwarding the combined packet to at least one specified base station transceiver for transmission to another mobile transceiver.

154. A method of communicating over a communication system as claimed in claim 148 wherein the base station transceivers use macrodiversity including the step of sending a packet from a plurality of base station transceivers to a mobile transceiver.

155. A method of communicating over a communication system as claimed in claim 154 wherein a mobile transceiver uses macrodiversity when receiving a signal from a base station transceiver including the step of receiving packets from a plurality of base station transceivers and diversity combining the packets.

156. A method of communicating over a communication system as claimed in claim 154 wherein the base station transceivers use different channels to transmit the packet.

157. A method of communicating over a communication system as claimed in claim 148 wherein the method used by mobile transceivers to allocate system resources includes:
identifying uplink channel usage in the range of the mobile terminal,
identifying one or more spare uplink channels, and
transmitting over the one or identified channels without negotiation with the base station.

158. A method of communicating over a communication system as claimed in claim 157 wherein the method used by mobile transceivers to allocate system resources includes identifying a spare uplink channel for transmission to minimise interference.

159. A method of communicating over a communication system as claimed in claim 148 wherein the method used by mobile transceivers to allocate system resources includes:
identifying downlink channel usage in the range of the mobile terminal,
identifying one or more spare downlink channels, and
instructing a transmitting mobile terminal to utilise the identified channel(s) for transmission.

160. A method of communicating over a communication system as claimed in claim 159 wherein the method used by the mobile transceivers to allocate system resources includes identifying a spare downlink channel for transmission to minimise interference.

161. A method of communicating over a communication system as claimed in claim 157 wherein the method used by mobile transceivers to allocate system resources includes negotiating the number of links with a receiving mobile transceiver.

162. A method of communicating over a communication system as claimed in claim 157 wherein the method used by mobile transceivers to allocate system resources includes splitting data to be transmitted into multiple streams and transmit each stream over a separate link.

163. A method of communicating over a communication system as claimed in claim 157 wherein the method used by mobile transceivers to allocate system resources includes stopping using a link if the amount of available channel resources reduces.

164. A method of communicating over a communication system as claimed in claim 148 wherein the method used by mobile transceivers to transmit a data stream from a first mobile terminal to a second mobile terminal over a communication system includes:
identifying one or more spare channels for the downlink to the second terminal,
separating the data stream into multiple portions according to the number of identified spare channels, and
transmitting the multiple portions over the spare channels to the second terminal.

165. A method of communicating over a communication system as claimed in claim 148 the method communicating includes using data packets each including a synchronisation sequence and a payload sequence, providing a distinction between payload sequences and synchronisation sequences in the signal to be transmitted by a mobile transceiver by scanning the payload sequence to determine any portions of the sequence that could be detected as a synchronisation sequence, introducing errors into the portions of the payload sequence, wherein the introduced errors are within an error correction capability of a payload error correction code.

166. A method of communicating over a communication system as claimed in claim 148 further including at least one register arranged communicate over the communication system and adapted to store at least a portion of the base station transceiver and time slot allocations of the mobile transceivers.

167. A method of communicating over a communication system as claimed in claim 166 wherein the method of allocating system resources includes the step of a mobile transceiver requesting information of available base station transceivers slots and channels.

168. A method of communicating over a communication system as claimed in claim 148 wherein a mobile transceiver uses a register to find the primary and secondary destination base station transceivers or a destination mobile transceiver.

169. A method of estimating a transition in a signal including the steps of:
sampling an incoming signal,
comparing the sample levels in a first group of samples with the sample levels in a second group of samples,
comparing the sample levels of samples within the first group of samples,
comparing the sample levels of samples within the second group of samples,
comparing the sample level of a middle sample with an adjacent middle sample where the middle samples are between the first group of samples and the second group of samples, and
estimating a transition point in the signal from the comparisons.

170. A method of estimating a transition in a signal as claimed in claim 169 wherein the middle samples do not form part of the either the first group of samples or the second group of samples.

171. A method of estimating a transition in a signal as claimed in claim 169 wherein a continuous sliding window of six samples is analysed, the first group of samples containing the first two samples, and the second group of samples containing the last two samples.

172. A method of estimating a transition in a signal as claimed in claim 169 wherein a transition point is estimated to be between the middle samples if the middle samples are different, the samples in the first group are the same, the samples in the second group are the same and the samples in the first group are different to the samples in the second group.

173. A circuit for detecting a transition in a signal, the circuit adapted to:
sample an incoming signal at at least twice the bit rate of the incoming signal,
compare the sample levels in a first group of samples with sample levels in a second group of samples,
compare sample levels of samples in the first group,
compare sample levels of samples in the second group,
compare the sample level of a middle sample with an adjacent middle sample where the middle samples are between the first and second groups, and
from the comparisons output an estimate of a transition point in the signal.

174. A communication system that carries out synchronisation between communicating transceivers by:
sampling an incoming signal at at least twice the bit rate of the incoming signal,
comparing the sample levels in a first group of samples with sample levels in a second group of samples,
comparing sample levels of samples in the first group,
comparing sample levels of samples in the second group,
comparing the sample level of a middle sample with an adjacent middle sample where the middle samples are between the first and second groups, and
from the comparisons output an estimate of a transition point in the signal.

175. A method for synchronising the clocks of a first node and a second node in a network including the steps of:
at a first time according to the clock of the first node sending a first synchronisation message from the first node to the second node,
at a second time according to the clock of the second node sending a second synchronisation message from the second node to the first node,
determining a first difference as the difference between the time on the first clock when the first message was sent and the time on the second clock when the first message was received,
determining a second difference as the difference between the time on the second clock then the second message was sent and the time on the first clock when the second message was received,
determining a clock error as the average of the difference between the first and second differences, and
adjusting the clock of either the first node or the second node by the clock error.

176. A method for synchronising the clocks of a first node and a second node in a network as claimed in claim 175 wherein the clocks of both nodes are adjusted to reduce the clock error.

177. A method for synchronising the clocks of a first node and a second node in a network as claimed in claim 175 further including the step of when the first node receives the second message the first node sends a third message to the second node including the time of receipt of the second message at the first node.

178. A method for synchronising the clocks of a first node and a second node in a network as claimed in claim 175 further including the step of sending a request from one node to the other node containing the time of the one node and adjusting the time of the other node to that of the one node prior to the first node sending a first message.

179. A network including a first node with a first clock and a second node with a second clock wherein to synchronise the first and second clocks:
the first node is adapted to send a first synchronisation message to the second node at a first time according to the clock of the first node,
the second node is adapted to send a second synchronisation message to the first node at a second time according to the clock of the second node,
one node is adapted to determine a first difference as the difference between the time on the first clock when the first message was sent and the time on the second clock when the first message was received,
one node is adapted to determine a second difference as the difference between the time on the second clock then the second message was sent and the time on the first clock when the second message was received,
one node is adapted to determine a clock error as the average of the difference between the first and second differences, and
adjusting the clock of either the first node or the second node by the clock error.

180. A network including a first node with a first clock and a second node with a second clock as claimed in claim 179 wherein the first node is further adapted to send a third message to the second node including the time of receipt of the second message at the first node when the first node receives the second message the first node, and the second node is adapted to calculate the clock error.

181. A network including a first node with a first clock and a second node with a second clock as claimed in claim 179 wherein one node is adapted to send a request to the other node containing the time of the one node and the other node is adapted to adjust the time of the clock of the other node to that of the one node prior to the first node sending a first message.

182. A communication system utilising a local area network, the network including a first node with a first clock and a second node with a second clock wherein to synchronise the first and second clocks:
the first node is adapted to send a first synchronisation message to the second node at a first time according to the clock of the first node,
the second node is adapted to send a second synchronisation message to the first node at a second time according to the clock of the second node,
one node is adapted to determine a first difference as the difference between the time on the first clock when the first message was sent and the time on the second clock when the first message was received,
one node is adapted to determine a second difference as the difference between the time on the second clock then the second message was sent and the time on the first clock when the second message was received,
one node is adapted to determine a clock error as the average of the difference between the first and second differences, and
adjusting the clock of either the first node or the second node by the clock error.

183. A communication system utilising a local area network, the network including a first node with a first clock and a second node with a second clock as claimed in claim 182 wherein the first node is further adapted to send a third message to the second node including the time of receipt of the second message at the first node when the first node receives the second message the first node, and the second node is adapted to calculate the clock error.

184. A communication system utilising a local area network, the network including a first node with a first clock and a second node with a second clock as claimed in claim 182 wherein one node is adapted to send a request to the other node containing the time of the one node and the other node is adapted to adjust the time of the clock of the other node to that of the one node prior to the first node sending a first message.

185. A method of allocating communication resources for a mobile terminal in a communication system that utilises a base station network including the steps of:
identifying uplink channel usage in the range of the mobile terminal,
identifying one or more spare uplink channels, and
transmitting over the one or identified channels without negotiation with the base station.

186. A method of allocating communication resources for a mobile terminal in a communication system that utilises a base station network including the steps of:
identifying downlink channel usage in the range of the mobile terminal,
identifying one or more spare downlink channels, and
instruction a transmitting mobile terminal to utilise the identified channel(s) for transmission.

187. A method of transmitting a data stream from a first mobile terminal to a second mobile terminal over a communication system including the steps of:
identifying one or more spare channels for the downlink to the second terminal,
separating the data stream into multiple portions according to the number of identified spare channels, and
transmitting the multiple portions over the spare channels to the second terminal.

188. A communication system in which data is transmitted in packets wherein before transmitting data a transmitter provides a distinction between payload sequences and synchronisation sequences in the signal by scanning the payload sequence to determine any portions of the sequence that could be detected as a synchronisation sequence, introducing errors into the portions of the payload sequence, and wherein the introduced errors are within an error correction capability of a payload error correction code.

189. A communication system as claimed in claim 188 wherein errors are introduced into the payload data by toggling binary data bits.

190. A communication system including at least one register that can communicate over the communication system and adapted to store at least a portion of the network configuration information of the communication system.
